(19) United States
(12) Patent Application Publication
(10) Pub. No.: US 2024/0273398 A1
(43) Pub. Date: Aug. 15, 2024

(54) APPARATUS, METHOD, AND COMPUTER PROGRAM PRODUCT FOR CONFIGURATION, ASSOCIATION, REGISTRATION, TRAINING, AND MONITORING OF MACHINE LEARNING MODELS FOR OPERATIONAL SYSTEMS

(71) Applicant: Honeywell International Inc., Charlotte, NC (US)

(72) Inventors: Bhabesh Chandra Acharya, Bangalore (IN); Kushagra Thakur, Atlanta, GA (US); Kumaresh Baabu, Bangalore (IN)

(21) Appl. No.: 18/167,955

(22) Filed: Feb. 13, 2023

(51) Int. Cl. G06N 20/00

(52) U.S. Cl. CPC G06N 20/00

(57) ABSTRACT

A platform for developing, configuring, training, deploying, executing, controlling access to, and/or monitoring machine learning models for operational systems is implemented by generating model association metadata based on model configuration data identifying machine learning model(s) and operational system context data identifying object(s) associated with one or more operational systems. The model association metadata defines associations between the machine learning model(s) and the object(s). For each association defined by the model association metadata, the machine learning model is trained according to the corresponding model training pipeline based on operational data associated with the object identified in the defined association, and each trained machine learning model (for each defined association) is registered in a trained model registry. The trained machine learning models in the trained model registry are executed according to parameters provided for each defined association, and each execution is monitored to detect model drift and/or trigger retraining.

### TECHNICAL FIELD

Embodiments of the present disclosure generally relate to machine learning systems, and specifically, in some examples, to machine learning systems for monitoring, maintaining, and/or controlling operational systems.

### BACKGROUND

Applicant has identified example technical challenges and difficulties associated with current solutions for developing, configuring, training, executing, and monitoring machine learning models for operational systems. Through applied effort, ingenuity, and innovation, Applicant has solved problems relating to developing, configuring, training, executing, and monitoring machine learning models for operational systems.

### BRIEF SUMMARY

According to one aspect, example embodiments of the present disclosure include an apparatus comprising at least one processor and at least one non-transitory memory comprising program code stored thereon. The at least one non-transitory memory and the program code are configured to, with the at least one processor, cause the apparatus to at least receive model configuration data and operational system context data and generate model association metadata based at least in part on the model configuration data and the operational system context data. The model configuration data identifies one or more machine learning models and a model training pipeline associated with each of the one or more machine learning models. The operational system context data identifies one or more objects associated with one or more operational systems. The model association metadata defines associations between the one or more machine learning models and the one or more objects. The at least one non-transitory memory and the program code are further configured to, with the at least one processor, cause the apparatus to at least, for each association between a particular machine learning model and a particular object of the associations defined by the model association metadata, train the particular machine learning model according to the model training pipeline associated with the particular machine learning model in the model configuration data based at least in part on operational data associated with the particular object, for each trained machine learning model, generate trained model metadata associated with the trained machine learning model based at least in part on the model association metadata, and, for each trained machine learning model, register the trained machine learning model in a trained model registry, including storing a trained model artifact representing the trained machine learning model and the trained model metadata associated with the trained machine learning model in a data repository associated with the trained model registry.

In some embodiments, the model association metadata comprises model training parameters and model deployment parameters corresponding to each association between a particular machine learning model and a particular object of the associations defined by the model association metadata.

In some embodiments, each trained machine learning model registered in the trained model registry is executed based at least in part on the stored trained model artifact and trained model metadata corresponding to the trained machine learning model.

In some embodiments, the trained model metadata for each trained machine learning model comprises an indication of whether the trained machine learning model is to be deployed, an execution schedule for the trained machine learning model, one or more execution types for the trained machine learning model, and/or one or more deployment endpoints for the trained machine learning model. The one or more execution types may include real time execution and/or batch execution.

In some embodiments, the model association metadata is generated based at least in part on model association input received via a model association interface.

In some embodiments, the one or more objects associated with the one or more operational systems include one or more assets of the one or more operational systems, one or more sites containing the one or more operational systems, and/or one or more alarms defined for the one or more operational systems.

In some embodiments, the operational system context data comprises metadata associated with various components of the one or more operational systems and/or an ontology model describing one or more associations between various components of the one or more operational systems.

In some embodiments, the at least one non-transitory memory and the program code are configured to, with the at least one processor, further cause the apparatus to at least monitor execution of each trained machine learning model registered in the trained model registry based at least in part on predefined monitoring criteria. The monitoring of the execution of each trained machine learning model registered in the trained model registry may comprise, in response to detecting model drift associated with a trained machine learning model exceeding a predefined drift threshold of the predefined monitoring criteria based at least in part on the execution of the trained machine learning model, generating a model drift notification associated with the trained machine learning model and/or triggering retraining of the trained machine learning model.

According to another aspect, embodiments of the present invention feature a method comprising receiving model configuration data and operational system context data and generating model association metadata based at least in part on the model configuration data and the operational system context data. The model configuration data identifies one or more machine learning models and a model training pipeline associated with each of the one or more machine learning models. The operational system context data identifies one or more objects associated with one or more operational systems. The model association metadata defines associations between the one or more machine learning models and the one or more objects. The method further comprises, for each association between a particular machine learning model and a particular object of the associations defined by the model association metadata, training the particular machine learning model according to the model training pipeline associated with the particular machine learning model in the model configuration data based at least in part on operational data associated with the particular object, for each trained machine learning model, generating trained model metadata associated with the trained machine learning model based at least in part on the model association metadata, and, for each trained machine learning model, registering the trained machine learning model in a trained model registry, including storing a trained model artifact representing the trained machine learning model and the trained model metadata associated with the trained machine learning model in a data repository associated with the trained model registry.

According to another aspect, embodiments of the present invention feature a computer program product comprising at least one non-transitory computer-readable storage medium having computer-readable program code portions stored therein. The computer-readable program code portions comprise an executable portion configured to: receive model configuration data and operational system context data and generate model association metadata based at least in part on the model configuration data and the operational system context data. The model configuration data identifies one or more machine learning models and a model training pipeline associated with each of the one or more machine learning models. The operational system context data identifies one or more objects associated with one or more operational systems. The model association metadata defines associations between the one or more machine learning models and the one or more objects. The computer-readable program code portions comprise an executable portion configured to: for each association between a particular machine learning model and a particular object of the associations defined by the model association metadata, train the particular machine learning model according to the model training pipeline associated with the particular machine learning model in the model configuration data based at least in part on operational data associated with the particular object, for each trained machine learning model, generate trained model metadata associated with the trained machine learning model based at least in part on the model association metadata, and, for each trained machine learning model, register the trained machine learning model in a trained model registry, including storing a trained model artifact representing the trained machine learning model and the trained model metadata associated with the trained machine learning model in a data repository associated with the trained model registry.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an exemplary machine learning platform system, in accordance with at least some example embodiments of the present disclosure;

FIG. 4 illustrates a visualization of an example computing environment for training and using machine learning models, in accordance with at least some example embodiments of the present disclosure;

FIG. 5 is an illustration of an example machine learning platform system having a distributed configuration between a realm plane and a tenant plane, in accordance with at least some example embodiments of the present disclosure;

FIG. 6 is an illustration of inheritance from the tenant plane to the realm plane within an example machine learning platform system having a distributed configuration, in accordance with at least some example embodiments of the present disclosure;

FIG. 7 is a flowchart depicting an example process for developing, configuring, training, and/or deploying machine learning models for operational systems, in accordance with at least some example embodiments of the present disclosure;

FIG. 8 is a flowchart depicting an example process for generating model association metadata in a machine learning platform system, in accordance with at least some example embodiments of the present disclosure;

FIG. 9 is a flowchart depicting an example process for executing machine learning models for operational systems, in accordance with at least some example embodiments of the present disclosure; and

FIG. 10 is a flowchart depicting an example process for monitoring machine learning models for operational systems, in accordance with at least some example embodiments of the present disclosure.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

Operational systems such as building systems (e.g., heating, ventilation, and air conditioning (HVAC) systems, building automation systems, security systems) and/or industrial systems (e.g., manufacturing systems, sorting and distribution systems) are configured, in some examples, to monitor and/or control various physical aspects of a premises, building, site, location, environment, mechanical system, industrial plant or process, laboratory, manufacturing plant or process, vehicle, utility plant or process, and/or the like. An operational system comprises various assets, including, in some examples, equipment (e.g., controllers, sensors, actuators) configured to perform the functionality attributed to the operational system and/or components, devices, and/or subsystems of the operational system. In some examples, the operational system, via its various assets, may monitor and/or control operation of a residential or commercial building or premises (e.g., HVAC systems, security systems, building automation systems, and/or the like). In other examples, the operational system may monitor and/or control operation of a manufacturing plant (e.g., manufacturing machinery, conveyor belts, and/or the like). In yet other examples, the operational system may monitor and/or control operation of a vehicle.

Often, a given enterprise may be responsible for the management of several operational systems, across several sites and locations, each comprising several (e.g., possibly thousands) of assets. Management of such systems often includes monitoring conditions and/or performance of the systems' assets, facilitating and/or performing service on or physical maintenance of the assets, and/or controlling the assets in order to optimize the assets' and systems' performance and/or fulfill other objectives of the enterprise.

Enterprise performance management (EPM) systems have been proposed to monitor and maintain operational systems. For example, in some operational systems, it has been proposed to communicatively connect operational system(s), including assets of the operational system(s), to a remote monitoring system (e.g., a cloud platform) configured to aggregate operational data with respect to some or all of the assets of one or more operational systems (e.g., deployed at one or more sites or locations). This operational data may comprise sensor data (e.g., generated via assets such as sensors of the operational system) or any other data generated with respect to and/or describing operation of the operational systems and/or assets thereof. The monitoring system may also aggregate and/or maintain operational system context data defining various attributes (e.g., relationships, types, locations, roles) associated with the assets of the operational system. This operational data and operational system context data may be collected, archived, and consulted in order to provide visibility into and perform various control operations with respect to the operational system(s), for example. These monitoring systems may be configured to provide, for each enterprise, an enterprise-wide, top-to-bottom, historical and/or real-time, view of the status of various processes, assets, people, and/or other objects associated with all of the operational system(s) managed by the enterprise. The monitoring systems may be configured to generate and present insights (e.g., predictions and/or recommendations) for optimizing performance of the operational system(s) and assets thereof. These insights are often generated using machine learning models, which may be developed, configured, and/or trained using one or more machine learning algorithms.

However, developing and/or deploying these machine learning models for managing operational systems and assets thereof has taken place, in some examples, at the level of individual projects within a given enterprise, which individual projects may be associated with particular operational systems, particular assets or groups of assets within an operational system, and/or particular individuals, groups of individuals, and/or departments within the enterprise. For example, an individual project involving the development and/or deployment of a machine learning model may be directed to solving a problem specifically with respect to a particular set of assets and, as such, may be visible and/or accessible only to individuals and systems associated with the particular set of assets, with local (as opposed to enterprise-wide) development and deployment of the models, local execution of training processes for training the models, and/or locally determined processes for serving the models, all of which may differ across different projects and/or models. In this context, configuration and deployment of machine learning models (and/or associated data analysis and calculations) can be time consuming and error prone.

Examples of the present disclosure concern a machine learning platform that combines model development capability with domain context awareness specific to the management of operational systems. The present disclosure combines domain objects (e.g., representing assets of operational systems and/or other objects associated with the operational systems) with processes for effective model training and multi-pronged model serving and timely model execution. The presently disclosed machine learning platform provides a standard way to catalog and deploy analytical workflows and/or machine learning models and to map said workflows and/or models to different domain-specific objects (e.g., associated with different operational systems). The presently disclosed machine learning platform also provides monitoring of analytics workflows and/or machine learning models to detect the need for and/or to trigger one or more actions to address any degradation or issues with model performance. The machine learning platform enables customization of pre-existing machine learning models for use in specific contexts (e.g., in particular projects concerning particular operational systems, particular assets, and/or particular enterprises). Data sets associated with the machine learning models can be made accessible across an entire enterprise, and the same models developed and configured on the platform can be associated with different objects, allowing for model training, serving, and monitoring that is configured for different, specific contexts across the enterprise.

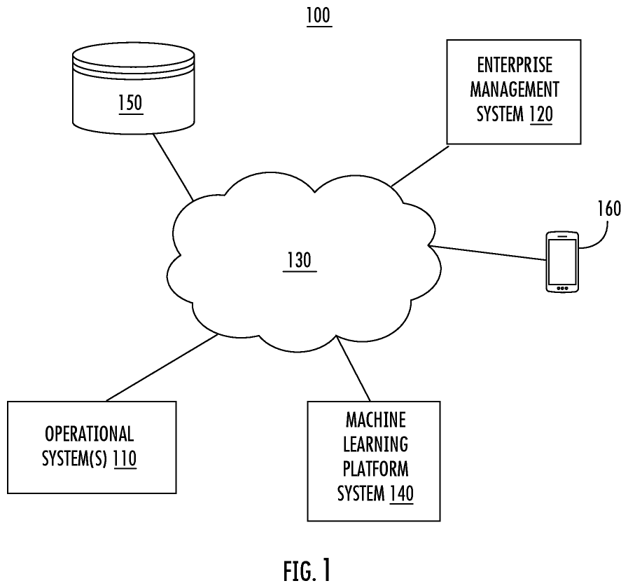

FIG. 1 illustrates an exemplary block diagram of an environment 100 in which embodiments of the present disclosure may operate. Specifically, FIG. 1 illustrates one or more operational systems 110, a machine learning platform system 140, an enterprise management system 120, one or more data repositories 150, and one or more user devices 160, all connected to a network 130.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The one or more data repositories 150 may be configured to receive, store, and/or transmit data. In some embodiments, the one or more data repositories 150 store operational data collected from and/or associated with the one or more operational systems 110, operational system context data associated with the one or more operational systems 110, data and/or metadata associated with one or more machine learning models developed and/or deployed via the machine learning platform system 140, and/or data generated via the one or more machine learning models (e.g., insights, predictions, recommendations).

The one or more user devices 160 may be associated with users of the enterprise management system 110, the machine learning platform system 140, and/or the operational system(s) 110. In various embodiments, the enterprise management system 120 may cause data associated with the one or more operational systems 110 (e.g., including operational data collected from and/or associated with the operational systems 110 and/or data generated via the machine learning platform system 140) to be transmitted to and/or displayed on the user device(s) 160. The machine learning platform system 140 may cause data and/or interfaces associated with configuration, training, and/or deployment of one or more machine learning models to be transmitted to and/or displayed on the user device(s) 160.

Each of the one or more operational systems 110 may be configured to monitor and/or control various physical aspects of a premises, building, site, location, environment, mechanical system, industrial plant or process, laboratory, manufacturing plant or process, vehicle, and/or utility plant or process, to name a few examples, via one or more assets of the one or more operational systems 110. The assets may be physical components (e.g., implemented at least via hardware) installed, positioned, and/or deployed throughout the operational system(s) 110, including controllers, sensors, and/or actuators of various types, to list a few examples. The assets may include computing devices for executing instructions (e.g., stored in nonvolatile memory) for performing various functions of the operational system(s) 110, for example, by receiving sensor data from one or more sensors and controlling one or more actuators (e.g., based on the received sensor data). The assets may include field controllers of the operational system. In an example context, at least some of the assets of the operational system(s) 110 may each embody a computing device of one or more systems for operation of a residential building (e.g., HVAC (heating, ventilation, and air conditioning) assets, security assets, and/or the like) such as controllers for directing the functionality of actuators such as air handlers, blowers, condensers, chillers, and/or dampers, to list a few examples. In another example context, at least some of the assets of the operational system(s) 110 may each embody a computing device of one or more systems for operation of a manufacturing plant (e.g., HVAC assets, manufacturing machinery, conveyor belts, and/or the like) such as controllers for directing the functionality of actuators such as the manufacturing machinery and/or conveyor belts. Actuators of the one or more operational systems 110 may be activated and/or controlled to perform various physical operations of the operational system 110.

Sensors of the one or more operational system 110 may be configured to generate sensor data based on incorporated sensing elements and may include digital sensors, which generate and transmit digital sensor data based on conditions sensed by sensing elements of the sensors, and/or analog sensors, which produce analog signals based on conditions sensed by sensing elements of the sensors. The sensors may be configured to read and/or otherwise capture certain values associated with a premises, building, site, location, environment, mechanical system, industrial plant or process, laboratory, manufacturing plant or process, and/or utility plant or process, or operations associated therewith or therein.

During configuration, operation, and/or maintenance of the one or more operational systems 110, operational data associated with the one or more operational systems 110 may be generated. In one example, during periods of operation of the operational system(s) 110, assets of the operational system(s) 110 may generate operational data based on and/or indicative of said operation, including sensor data, operational status data, operating conditions data, and/or operation logs (e.g., indicating operations performed by the system or assets thereof), to list a few examples. In another example, during configuration of the operational system(s), assets of the operational system(s) 110 may generate and/or receive system and/or asset configuration data of the operational data. In yet another example, other types of operational data may be generated (e.g., by the operational system(s) and/or external systems for managing the operational system(s) and/or an enterprise associated therewith), including operational system maintenance data based on and/or indicative of maintenance and/or service operations performed with respect to the operational system(s) 110 and/or operational system performance data based on and/or indicative of performance of the operational system(s) 110 with respect to one or more objectives of the enterprise.

Additionally or alternatively, operational system context data may be generated with respect to the one or more operational systems 110. In one example, the enterprise management system 120 may be configured to manage and/or maintain the one or more operational systems 110, including receiving, retrieving, and/or aggregating data associated with the operational systems(s) 110 and generating the operational system context data based on the received, retrieved, and/or aggregated data.

In some examples, the operational system context data associated with a given operational system may comprise metadata associated with various components and/or assets of the given operational system, for example, defining various attributes and/or characteristics of the assets and/or associations or relationships between the various assets. In one example, the operational system context data for an operational system may comprise an ontology model providing a representation of each of the various assets of the operational system, classification of the assets into various groups or categories, definition of various attributes of the assets and/or categories, and/or definition of associations between the various objects and/or categories referenced throughout the operational system context data. The operational system context data may include identification information for individual assets of the operational system, type information for the individual assets assigning types to each of the assets, properties associated with the identification information and/or the type information, locations of the assets within the operational system and/or an environment where the operational system is installed, functional and/or physical locations of the assets with respect to each other, relationships between the assets with respect to each other, relationships between types of the assets with respect to each other, and/or roles of the assets and/or types of assets within the operational system and/or within subsystems of the operational system, to name a few examples. The operational system context data associated with a given operational system may comprise data and/or metadata associated with any objects associated with the given operational system, which objects may include assets and/or equipment of the one or more operational systems 110, sensors included in and/or associated with the one or more operational systems 110, alarms or alarm tasks associated with the one or more operational systems 110 (e.g., concerning required or recommended maintenance, anomalies, unsafe operating conditions), sites, locations, or regions containing the one or more operational systems 110 and/or any assets thereof, and/or individuals associated with the one or more operational systems 110, to name a few examples. The operational system context data associated with a given operational system may comprise data and/or metadata defining objects representing management, maintenance, and/or service tasks associated with various assets of the operational systems, including, for example, alarms associated with certain assets or types of assets and representing configuration settings for generating alarm notifications concerning the need for certain maintenance operations associated with the assets or asset types.

The operational system context data may comprise an extensible object model and/or an extensible graph-based object model associated with the operational system(s) 110. The operational system context data may comprise knowledge graphs that model assets and/or processes of and/or associated with the operational system(s) 110. In one example, knowledge graphs of the operational system context data may define a collection of nodes and links that describe or represent real-world connections between the operational system(s) 110 and/or assets thereof. A knowledge graph of the operational system context data may describe real-world entities (e.g., assets) and their interrelations organized in a graphical interface, may define possible classes and relations of entities or objects associated with the operational system(s) 110 in a schema, may enable interrelating arbitrary entities or objects with each other, and/or may cover various topical domains associated with the operational system(s) 110. Knowledge graphs of the operational system context data may define large networks of entities (e.g., assets), semantic types of the entities, properties of the entities, and relationships between the entities. The knowledge graphs of the operational system context data may describe a network of objects that are relevant to a specific domain or to an enterprise. Knowledge graphs of the operational system context data are not limited to abstract concepts and relation but can also contain instances of objects, such as, for example, documents and datasets. In some embodiments, the knowledge graphs of the operational system context data may include resource description framework (RDF) graphs. As used herein, a “RDF graph” is a graph data model that formally describes the semantics, or meaning, of information. The RDF graph also represents metadata (e.g., data that describes data). According to various embodiments, knowledge graphs of the operational system context data may also include a semantic object model, which may be a subset of a knowledge graph that defines semantics for the knowledge graph. For example, a semantic object model may define a schema for a knowledge graph.

The operational data and/or operational system context data associated with the one or more operational systems 110 may be aggregated and/or stored in the one or more data repositories 150 and/or may be accessible by the machine learning platform system 140 and/or the enterprise management system 120.

The machine learning platform system 140 may be a computing system or device (e.g., server system) configured via hardware, software, firmware, and/or a combination thereof, to develop, configure, train, deploy, execute, control access to, and/or monitor one or more machine learning models for generating insights, predictions, and/or recommendations associated with the one or more operational systems 110.

More particularly, the machine learning platform system 140 may be configured to receive and/or generate model configuration data. The model configuration data may identify and/or define the one or more machine learning models and/or a model training pipeline associated with each of the one or more machine learning models. The machine learning platform system 140 may also be configured to receive operational system context data associated with the one or more operational systems 110. The machine learning platform system 140 may be configured to store the model configuration data and/or the operational system context data in a data repository 150 associated with the machine learning platform system 140.

The machine learning platform system 140 may be configured to generate model association metadata based at least in part on the model configuration data and the operational system context data. The model association metadata may define associations between the one or more machine learning models and one or more objects (associated with the one or more operational systems 110) defined in the operational system context data. The machine learning platform system 140 may be configured to store the model association metadata in a data repository 150 associated with the machine learning platform system 140.

For each association between a particular machine learning model (of the one or more machine learning models defined and/or identified by the model configuration data) and a particular object (of the one or more objects defined in the operational system context data) of the associations defined by the model association metadata, the machine learning platform system 140 may be configured to train the particular machine learning model according to the model training pipeline associated with the particular machine learning model in the model configuration data based at least in part on operational data associated with the particular object. For example, each of the one or more machine learning models defined in the model configuration data may be trained multiple times, with each training being performed using a distinct training data set (e.g., comprising operational data) specific to particular object(s) associated with the machine learning model in the model association metadata, and such training may result in multiple instances of a trained machine learning model associated with each of the machine learning models identified and/or defined in the model configuration data, with each trained machine learning model being specifically associated with and/or trained specifically with respect to corresponding object(s) identified in an association included in the model association metadata.

For each trained machine learning model, the machine learning platform system 140 may be configured to generate trained model metadata associated with the trained machine learning model based at least in part on the model association metadata. Additionally, for each trained machine learning model, the machine learning platform system 140 may be configured to register the trained machine learning model in a trained model registry, including storing a trained model artifact (e.g., generated during the training process) representing the trained machine learning model and the trained model metadata associated with the trained machine learning model in a data repository (e.g., of the one or more data repositories 150) associated with the trained model registry.

Each trained machine learning model registered in the trained model registry may be executed based at least in part on the stored trained model artifact and trained model metadata corresponding to the trained machine learning model. In one example, the machine learning platform system 140 may be configured to execute and/or cause execution of each trained machine learning model based at least in part on the corresponding trained model artifact and trained model metadata. In another example, the machine learning platform system 140 may be configured to provide access by one or more external services to the trained model registry, and the one or more external services may execute the trained machine learning model(s) based on the model artifact and trained model metadata associated with the trained machine learning model(s). In some embodiments, the trained model metadata for each trained machine learning model may comprise an indication of whether the trained machine learning model is to be deployed, an execution schedule for the trained machine learning model, one or more execution types for the trained machine learning model, and/or one or more deployment endpoints for the trained machine learning model (e.g., the deployment endpoints representing external services and/or types of external services to which access to the trained machine learning model should be provided). In some embodiments, the trained model metadata for each trained machine learning model may comprise one or more execution types for the trained machine learning model, the one or more execution types including, in some example, real time execution and/or batch execution.

The machine learning platform system 140 may be configured to monitor execution of each trained machine learning model registered in the trained model registry based at least in part on predefined monitoring criteria. In one example, such monitoring may comprise, in response to detecting model drift associated with a trained machine learning model exceeding a predefined drift threshold (e.g., defined in the predefined monitoring criteria) based at least in part on the execution of the trained machine learning model, generating and/or transmitting a model drift notification associated with the trained machine learning model and/or triggering retraining of the trained machine learning model.

The machine learning platform system 140 may be configured to control access to the model configuration data, model association metadata, operational data, operational system context data, and/or trained model registry, for example, based at least in part on predefined access control criteria (e.g., permissions data indicating which users, enterprises, external services, and/or training processes are permitted to access which portions of the model configuration data, model association metadata, operational data, operational system context data, and/or trained model registry).

Output data (e.g., predictions, recommendations, and/or insights) resulting from the execution of the trained machine learning models registered in the trained model registry may be aggregated and/or stored in the one or more data repositories 150 and/or may be accessible to the machine learning platform system 140 and/or the enterprise management system 120.

The enterprise management system 120 may be a computing system or device (e.g., server system) configured via hardware, software, firmware, and/or a combination thereof, to present and/or process the output data resulting from the execution of the trained machine learning models registered in the trained model registry. For example, the enterprise management system 120 may present one or more insight interfaces within a graphical user interface (GUI) rendered on one or more displays of one or more of the user devices 160. The one or more insight interfaces may comprise one or more graphical elements for displaying the output data (e.g., including data resulting from processing the output data) and/or one or more interactable elements for receiving the insight presentation and/or analysis input, for example, as user input. The insight presentation and/or analysis input may represent one or more selections of presentation parameters for determining how the output data is displayed and/or one or more selections of analysis parameters for determining how the output data is processed, to name a few examples.

While FIG. 1 illustrates certain components as separate, standalone entities communicating over the network 130, various embodiments are not limited to this configuration. In other embodiments, one or more components may be directly connected and/or share hardware or the like.

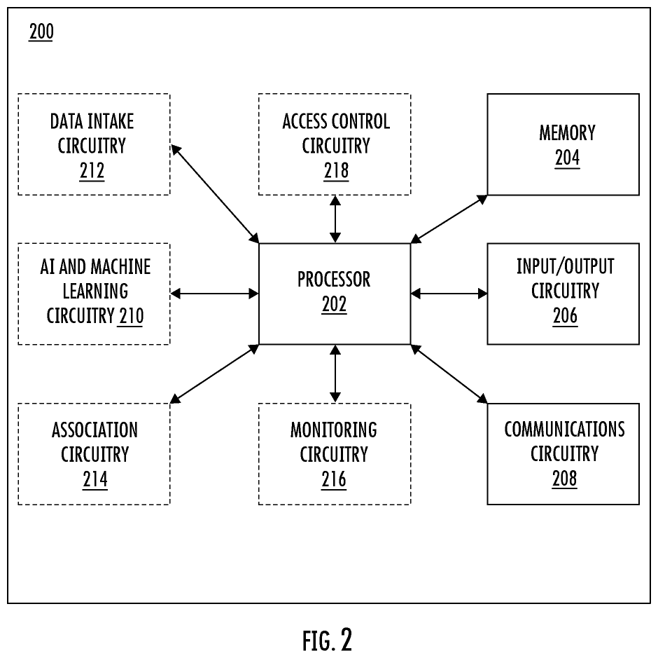

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. Examples of an apparatus 200 may include, but is not limited to, one or more components of one or more operational systems 110, a machine learning platform system 140, an enterprise management system 120, data repositories 150, and/or user devices 160. The apparatus 200 includes processor 202, memory 204, input/output circuitry 206, communications circuitry 208, and/or optional artificial intelligence (“AI”) and machine learning circuitry 210, data intake circuitry 212, association circuitry 214, monitoring circuitry 216, and/or access control circuitry 218. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, a device, system, or apparatus, such as apparatus 200 of one or more components of one or more operational systems 110, a machine learning platform system 140, an enterprise management system 120, data repositories 150, and/or user devices 160, may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry embodying the memory 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the one or more operational systems 110, including the operational data associated with the one or more operational systems 110. The data intake circuitry 212 may include hardware, software, firmware, and/or a combination thereof, designed and/or configured to capture, receive, request, and/or otherwise gather data associated with configuration of the one or more operational systems 110, including the operational system context data associated with the one or more operational systems 110. In some embodiments, the data intake circuitry 212 includes hardware, software, firmware, and/or a combination thereof, that communicates with one or more controller(s), device(s), component(s), unit(s), and/or the like within a particular operational system to receive particular data associated with such operations of the operational system. In some embodiments, the data intake circuitry 212 includes hardware, software, firmware, and/or a combination thereof, that communicates with an enterprise management system 120 to receive particular data associated with configuration of the operational system. The data intake circuitry 212 may support such operations for any number of individual operational systems associated with any number of enterprises. Additionally or alternatively, in some embodiments, the data intake circuitry 212 includes hardware, software, firmware, and/or a combination thereof, that retrieves particular data associated with one more operational system(s) from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for configuring, training, and/or executing one or more AI and machine learning models according to the model configuring, training, and/or executing operations and/or functionalities described herein. In one example, an apparatus 200 associated with the machine learning platform system 140 may comprise AI and machine learning circuitry 210 configured to develop, configure, and/or train one or more machine learning models and/or to store data associated with and/or defining the trained machine learning model(s) (e.g., trained model metadata, trained model artifacts, parameters, hyperparameters, training data sets, and/or data indicative thereof) in a data repository (e.g., of the one or more data repositories 150). In another example, an apparatus 200 associated with the machine learning platform system 140 and/or one or more external services (with access to the trained model registry maintained by the machine learning platform system 140) may comprise AI and machine learning circuitry 210 configured to receive data and/or metadata retrieve stored data associated with and/or defining one or more trained machine learning model(s) from a data repository (e.g., of the one or more data repositories 150), retrieve stored data (e.g., operational data) associated with the one or more trained machine learning models, and/or generate and/or store model output data (e.g., predictions, recommendations, insights) by executing the retrieved machine learning model(s) with respect to the retrieved operational data.

Association circuitry 214 may be included in the apparatus 200. The association circuitry 214 may include hardware, software, firmware, and/or a combination thereof designed and/or configured to perform model association functionality according to the model association operations and/or functionalities described herein. In one example, an apparatus 200 associated with the machine learning platform system 140 may comprise association circuitry 214 configured to generate model association metadata as defined and described herein.

Monitoring circuitry 216 may be included in the apparatus 200. The monitoring circuitry 216 may include hardware, software, firmware, and/or a combination thereof designed and/or configured to monitor execution of machine learning models according to the operations and/or functionalities described herein. In one example, an apparatus 200 associated with the machine learning platform system 140 may comprise monitoring circuitry 216 configured to monitor execution of each trained machine learning model registered in the trained model registry based at least in part on predefined monitoring criteria.

Access control circuitry 218 may be included in the apparatus 200. The access control circuitry 218 may include hardware, software, firmware, and/or a combination thereof designed and/or configured to control access to data and/or functionality according to the access control operations and/or functionalities described herein. In one example, an apparatus 200 associated with the machine learning platform system 140 may comprise monitoring circuitry 216 configured to control access to the model configuration data, model association metadata, operational data, operational system context data, and/or trained model registry based at least in part on predefined access control criteria (e.g., permissions data indicating which users, enterprises, external services, and/or training processes are permitted to access which portions of the model configuration data, model association metadata, operational data, operational system context data, and/or trained model registry).

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

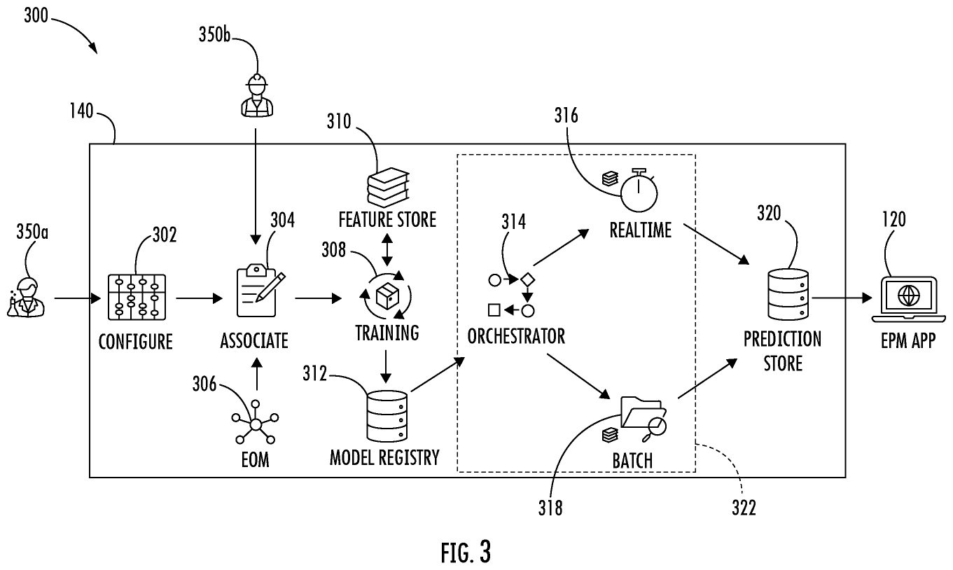

FIG. 3 is an illustration of an example machine learning platform system 140, in accordance with at least some example embodiments of the present disclosure. Specifically, FIG. 3 includes schematic depictions of example internal processes and components of the machine learning platform system 140 along with example data objects used by and/or produced by the example internal processes and/or components. The machine learning platform system 140 and/or apparatuses 200 associated therewith, for example, may be specially configured via hardware, software, firmware, and/or a combination thereof, to perform the various data processing and interactions described with respect to FIG. 3 to develop, configure, train, deploy, execute, control access to, and/or monitor one or more machine learning models for generating insights, predictions, and/or recommendations associated with the one or more operational systems 110.

In the illustrated example, the machine learning platform system 140 comprises, in some examples, a configuration process 302, an association process 304, an extensible object model 306, a training process 308, a feature store 310, a model registry 312, an orchestration process 314, a real time execution process 316, a batch execution process 318, a prediction store 320, and a monitoring process 322.

The configuration process 302 of the machine learning platform system 140 may be configured to perform and/or facilitate development and/or configuration of one or more machine learning models, including receiving and/or generating the model configuration data identifying and/or defining the one or more machine learning models (and/or a model training pipeline associated with each of the one or more machine learning models) as previously described. In some embodiments, the configuration process 302 may be configured to present one or more model configuration interfaces for receiving model configuration input associated with one or more machine learning models. For example, the configuration process 302 may be configured to present the one or more model configuration interfaces within a graphical user interface (GUI) rendered on one or more displays of one or more of the user devices 160. In another example, the configuration process 302 may be configured to present the one or more model configuration interfaces by exposing an application programming interface (API) configured to receive the model configuration input and/or model configuration data. The model configuration interface(s) may comprise one or more interactable elements for receiving the model configuration input, for example, as user input.

In some embodiments, the machine learning platform system 140 may be configured to generate model configuration data based at least in part on the model configuration input received via the one or more model configuration interfaces. The configuration process 302 may receive and/or generate the model configuration input based at least in part on detecting interactions (e.g., via the input/output circuitry 206) between the one or more model configuration interfaces and a configuration user 350a, which may be a data scientist tasked with development of one or more machine learning models generally relevant to maintenance and/or operation of operational systems, for example. The configuration process 302 may receive and/or generate the model configuration input based at least in part on receiving and/or processing requests via an API from one or more computing devices associated with the configuration user 350a. The model configuration input received via the model configuration interface(s) may comprise one or more data objects representing selections and/or indications of various properties, values, attributes, operations, functions, and/or identifiers representing, describing, and/or characterizing a machine learning model (of the one or more machine learning models).

The model configuration data associated with a given machine learning model (of the one or more machine learning models) may define the given machine learning model, including defining a model identifier associated with the given machine learning model, one or more parameters representing input data that the given machine learning model is configured to receive, defining one or more operations, calculations, and/or transformations that the given machine learning model is configured to perform with respect to the received input data, and/or defining one or more output operations and/or data parameters representing output data resulting from the one or more operations, calculations, and/or transformations with respect to the input data defined for the given machine learning model, which output data the given machine learning model is configured to output upon execution.

The model configuration data associated with a given machine learning model may comprise model training pipeline data. The model training pipeline data associated with a given machine learning model may define a training process for training the given machine learning model. For example, the model training pipeline data may define one or more parameters representing training input data that the training process is configured to receive, the training input data comprising and/or referencing, for example, one or more portions and/or data objects of the operational data and/or operational system context data accessible by the machine learning platform system 140. The model training pipeline data may define one or more training operations, calculations, and/or transformations to be performed as part of the training process with respect to the training input data. The model training pipeline data may define one or more training output operations and/or parameters representing training output data resulting from the one or more training operations, calculations, and/or transformations, which training output data the training process is configured to output upon execution (e.g., including trained model metadata and/or trained model artifacts). The training input data may define and/or identify one or more types of objects associated with one or more operational systems 110 and/or one or more types of data (e.g., associated with the one or more types of objects defined by the training input data) expected by the training process represented by the model training pipeline data. The one or more training operations defined by the model training pipeline data may be defined with respect to the one or more types of objects and/or the one or more types of data defined and/or identified by the training input data.

In some embodiments, the one or more model configuration interfaces presented by the configuration process 302 of the machine learning platform system 140 may include graphical elements, interactable elements, and/or API elements configured to receive model code input representing model code data defining a machine learning model. The one or more model configuration interfaces may include graphical elements, interactable elements, and/or API elements configured to receive sample data selection input representing selections of sample data sets and to cause execution of the machine learning model defined via the received model code against the selected sample data sets in a training, testing, and/or evaluation context. Sample data of the sample data sets may include and/or originate from the operational data and/or operational system context data accessible by the machine learning platform system 140 (e.g., stored in the one or more data repositories 150).

The association process 304 of the machine learning platform system 140 may be configured to perform and/or facilitate association operations of the one or more machine learning models, including receiving the operational system context data and the model configuration data and/or generating the model association metadata based at least in part on the received operational system context data and model configuration data, as previously described. In some embodiments, the association process 304 may receive the operational system context data in the form of an extensible object model 306, which may comprise knowledge graphs that model assets, processes, alarms, and/or other objects of and/or associated with the one or more operational systems 110.

Moreover, in some embodiments, the association process 304 may generate the model association metadata based at least in part on model association input received via one or more model association interfaces. More particularly, the association process 304 may be configured to present the one or more model association interfaces, which may be configured to receive model association input associated with one or more machine learning models. In one example, the association process 304 may be configured to present the one or more model association interfaces within a GUI rendered on one or more displays of one or more of the user devices 160. In another example, the association process 304 may be configured to present the one or more model association interfaces by exposing an API configured to receive the model association input and/or model association metadata. The model association interface(s) may comprise one or more interactable elements for receiving the model association input, for example, as user input. In the illustrated example, the association process 304 receives and/or generates the model association input based at least in part on detecting interactions (e.g., via the input/output circuitry 206) between the one or more model association interfaces and an association user 350b, which may be a technician and/or engineer tasked with maintenance and/or configuration of one or more particular operational systems (of the one or more operational systems 110), for example. The association process 304 may receive and/or generate the model association input based at least in part on receiving and/or processing requests via an API from one or more computing devices associated with the association user 350b. The model association input received via the model association interface(s) may comprise one or more data objects representing selections and/or indications of various properties, values, attributes, operations, functions, and/or identifiers representing, describing, and/or characterizing an association between a machine learning model (e.g., defined in the model configuration data) and one or more objects (and/or types of objects) associated with the one or more operational systems 110 (e.g., defined in the operational system context data).

In one example, the model association input received via the one or more model association interfaces may represent a selection of a selected machine learning model (of the one or more machine learning models defined via the model configuration data) and a selection of one or more selected objects or types of objects (defined via the operational system context data) associated with the one or more operational systems 110. Accordingly, the association process 304 may be configured to receive the model association input by presenting the model association interface(s) based at least in part on the model configuration data and/or the operational system context data (e.g., by presenting portions of the model configuration data and/or operational system context data along with interactable elements of the model association interface(s) configured to receive input representing selections of selected model(s) and/or selected object(s) represented by the presented portions of the model configuration data and/or operational system context data, by transmitting portions of the model configuration data and/or operational system context data and receiving and processing requests via an API representing selections of selected model(s) and/or selected object(s) of the model configuration data and/or operational system context data). The association process 304 may be configured to generate the model association metadata for a given machine learning model by generating the model association metadata for the given machine learning model to comprise an association between the selected machine learning model represented by the model association input received via the one or more model association interfaces and the one or more selected objects represented by the model association input received via the one or more model association interfaces.

In one example, the machine learning platform system 140 may expose a configuration API (of the one or more model configuration interfaces) configured to receive model configuration input including model training pipeline data associated with a given machine learning model. The machine learning platform system 140 may alternatively or additionally expose a pipeline association API (of the one or more model association interfaces) configured to receive pipeline association input (of the model association input) defining associations between model training pipelines represented by the model training pipeline data received via the configuration API and alarm objects (of the objects associated with the one or more operational systems 110) represented in the operational system context data. The machine learning platform system 140 may alternatively or additionally expose a context API (of the one or more model association interfaces) configured to receive and process requests for portions of the operational system context data (e.g., a hierarchy of assets and/or alarms represented in the operational system context data). The machine learning platform system 140 may present an object selection interface (of the one or more model association interfaces), which may be in the form of a user interface and/or an API, and which is configured to receive object selection input (of the model association input) indicating selections of selected objects (e.g., assets, alarms). In response to receiving, via the object selection interface, object selection input indicating selection of a selected object, the machine learning platform system 140 may initiate a training process for training the given machine learning model specifically with respect to (e.g., based on data associated with) the selected object.

The model association metadata may define associations between the one or more machine learning models and one or more objects associated with the one or more operational systems 110. For example, the model association metadata may comprise definitions of one or more associations between machine learning models (e.g., defined by the model configuration data) and one or more objects (associated with the one or more operational systems 110) defined in the operational system context data. Each definition of the definitions comprised by the model association metadata may comprise a model identifier representing a particular machine learning model associated with one or more object identifiers (respectively representing the one or more objects). The model identifier may refer to a corresponding identifier defined for a machine learning model in the model configuration data. Similarly, the object identifier(s) may respectively refer to corresponding identifier(s) defined for object(s) in the operational system context data.

The training process 308 of the machine learning platform system 140 may be configured to perform and/or facilitate model training operations with respect to the one or more machine learning models, including, for each association between a particular machine learning model (of the one or more machine learning models defined and/or identified by the model configuration data) and a particular object (of the one or more objects defined in the operational system context data) of the associations defined by the model association metadata, training the particular machine learning model according to the model training pipeline associated with the particular machine learning model in the model configuration data based at least in part on operational data associated with the particular object and generating and storing trained model metadata and a trained model artifact representing each trained machine learning model in the model registry 312.

In some embodiments, the training process 308 may be configured to receive and/or retrieve the operational data associated with the particular object from the feature store 310, which may be a data repository (e.g., of the one or more data repositories 150) configured to store, for particular objects associated with the one or more operational systems 110, particular data values corresponding to various independent variables referenced and/or used in the one or more machine learning models. In one example, the operational data from the feature store 310 may comprise any data associated with the operation of the one or more operational systems 110, including any data collected from the operational system(s) 110 (e.g., via the data intake circuitry 212) and/or any data generated and/or calculated from such data collected from the operational system(s) 110. Some or all of the operational data received from the feature store 310 may be generated based at least in part on performing one or more feature engineering processes (e.g., by the machine learning platform system 140 and/or other computing systems). In one example, the feature store 310 may be associated with a particular enterprise and may be configured to store any and all features of operational data associated with any and all operational systems 110 across the particular enterprise. The feature store 310 associated with the particular enterprise may be configured to store any and all features of operational data associated with (e.g., generated or engineered for) any and all machine learning models associated with the particular enterprise across the entire enterprise.

The training process 308 of the machine learning platform system 140 may be configured to train a given machine learning model by retrieving (e.g., from the data repository 150) the model configuration data associated with the given machine learning model identified in the model association metadata, determining and/or retrieving (e.g., from the feature store 310) a particular set of training input data that is generally defined by the model training pipeline data of the model configuration data associated with the given machine learning model but specific to the one or more objects particularly associated with the given machine learning model in the model association metadata, performing the one or more training operations, calculations, and/or transformations defined by the model training pipeline data with respect to the particular set of training input data, generating the trained model metadata and/or trained model artifact representing a trained instance of the given machine learning model according to the training output operations and/or parameters defined by the model training pipeline and based at least in part on the one or more training operations, calculations, and/or transformations, and storing the trained model metadata and/or trained model artifact in a data repository 150 associated with the trained model registry 312. In some embodiments, the training process 308 may be configured to train each machine learning model based at least in part on the model association metadata associated with the machine learning model. For example, the model association metadata associated with a machine learning model may comprise model training parameters defining various properties, attributes, details, specifications, and/or configuration settings describing and/or representing how the machine learning model should be trained in each instance (e.g., with respect to each association between the model and a particular object).

The orchestration process 314 of the machine learning platform system 140 may be configured to perform and/or facilitate model orchestration, deployment, and/or execution operations with respect to the one or more machine learning models, including, executing and/or causing execution of each trained machine learning model in the trained model registry 312 based at least in part on the corresponding trained model artifact and trained model metadata and/or based at least in part on the model association metadata.

In one example, the model association metadata associated with a machine learning model may comprise model training parameters and model deployment parameters corresponding to each association between a particular machine learning model and a particular object of the associations defined by the model association metadata

In some embodiments, the orchestration process 314 (and/or any external services performing the execution of the trained machine learning models) may be configured to execute and/or cause execution of each machine learning model based at least in part on the model association metadata associated with the machine learning model. For example, the model association metadata associated with a machine learning model may comprise model deployment parameters defining various properties, attributes, details, specifications, and/or configuration settings describing and/or representing how the machine learning model, once trained, should be deployed and/or executed in each instance (e.g., with respect to each association between the model and a particular object).

In some embodiments, the orchestration process 314 (and/or any external services performing the execution of the trained machine learning models) may be configured to execute and/or cause execution of each machine learning model based at least in part on the trained model metadata for each trained machine learning model, which may comprise an indication of whether the trained machine learning model is to be deployed, an execution schedule for the trained machine learning model, one or more execution types for the trained machine learning model, and/or one or more deployment endpoints for the trained machine learning model (e.g., the deployment endpoints representing external services and/or types of external services to which access to the trained machine learning model should be provided). In some embodiments, the trained model metadata for each trained machine learning model may comprise one or more execution types for the trained machine learning model, the one or more execution types including real time execution and/or batch execution. Moreover, in some embodiments, the trained model metadata for each trained machine learning model may comprise and/or may be generated to reflect model deployment parameters specified for the machine learning model as part of the association in the model association metadata of the machine learning model on which the trained model is based with the particular object(s) to which the trained model is associated.

In the illustrated example, the orchestration process 314 executes and/or causes execution of each trained machine learning model in the trained model registry 312 by deploying the trained machine learning model for real time execution and serving, deploying the trained machine learning model for batch execution, and/or triggering execution of the real time execution process 316 and/or the batch execution process 318 based at least in part on execution schedules provided in the model association metadata and/or trained model metadata and/or the execution type specified for the trained machine learning model in the model association metadata and/or in the trained model metadata.

In some embodiments, the orchestration process 314 may be configured to monitor the trained model registry 312 on a continuous or continual basis in order to detect the addition of newly trained models to the trained model registry 312. In one example, in response to detecting a newly available trained machine learning model in the trained model registry 312, the orchestration process 314 may deploy the trained machine learning model for real time and/or batch execution according to the deployment parameters provided in the model association metadata and/or trained model metadata.

The orchestration process 314 may deploy a trained machine learning model for real time and/or batch execution and serving by sending the trained model (e.g., in the form of the trained model artifact and/or trained model metadata) to one or more deployment endpoints (e.g., via APIs), which may be internal and/or external services or servers configured to receive execution requests with respect to one or more trained machine learning models (e.g., as part of a web, web app, software-as-a-service (SaaS) or content service operation) and execute the trained machine learning model in response to receiving the execution requests. The orchestration process 314 may be configured to deploy the trained machine learning model based at least in part on deployment parameters indicated in the model association metadata and/or trained model metadata, for example, by determining which deployment endpoints to send the trained model to and/or which configuration settings to send to the selected deployment endpoints along with the trained model based at least in part on the deployment parameters. In response to deploying a trained machine learning model for real time and/or batch execution, the orchestration process 314 may update the trained model registry 312 to include deployment endpoint data (e.g., endpoint address data, uniform resource locator (URL) data) associated with the deployed trained machine learning model.

In some embodiments, the orchestration process 314 may be configured to retrieve from the trained model registry 312 model identifiers representing and/or associated with some or all of the trained machine learning models registered in the trained model registry 312. Based at least in part on the retrieved model identifiers, the orchestration process 314 may determine and/or retrieve deployment parameters associated with each trained machine learning model represented by the model identifiers retrieved from the trained model registry 312. For example, for a given model identifier retrieved from the trained model registry 312, the orchestration process 314 may obtain from the model association metadata and/or from the trained model metadata the deployment parameters associated with the trained machine learning model represented by and/or associated with the given model identifier. Based at least in part on the deployment parameters, the orchestration process 314 may determine whether to deploy the trained machine learning model represented by and/or associated with the given model identifier for real time and/or batch execution. Moreover, based at least in part on the deployment parameters, the orchestration process 314 may determine which deployment endpoints to send the trained model to and/or which configuration settings to send to the selected deployment endpoints along with the trained model.

The orchestration process 314 may be configured to invoke (e.g., trigger execution of) the real time execution process 316 and/or the batch execution process 318 based at least in part on configuration settings and/or parameters (e.g., execution schedules) indicated for particular machine learning models in the model association metadata and/or the trained model metadata. In one example, the orchestration process 314 may generate and/or retrieve an updated set of input data specific to a trained machine learning model at periodic intervals based at least in part on the model association metadata and/or trained model metadata and transmit the updated set of input data to the real time execution process 316 and/or the batch execution process 318 in conjunction with invocation of the respective process. The orchestration process 314 invoking the real time and/or batch execution of the trained machine learning model may comprise retrieving from the trained model registry 312 deployment endpoint data (e.g., endpoint address data, URL data) associated with the deployed trained machine learning model, and using the retrieved deployment endpoint data to invoke execution of the trained model (e.g., by generating and transmitting an execution request to one or more addresses represented in the endpoint address data and/or URL data).

In some embodiments, upon generating and/or retrieving an updated set of input data specific to the trained machine learning model and retrieving from the trained model registry 312 deployment endpoint data associated with the trained machine learning model, the orchestration process 314 (e.g., via the real time execution process 316 and/or the batch execution process 318), may transmit the updated input data to one or more deployment endpoints (e.g., represented by the deployment endpoint data), for example, by generating and transmitting to an API of each of the one or more deployment endpoints an execution request (e.g., API call), which may include the updated input data. The orchestration process 314 (e.g., via the real time execution process 316 and/or the batch execution process 318) may receive from the one or more deployment endpoints output data (e.g., predictions, recommendations, insights) generated from execution of the trained machine learning model (e.g., by the one or more deployment endpoints based at least in part on the updated input data) and store the output data in a data repository (e.g., of the one or more data repositories 150) associated with the prediction store 320.

In some embodiments, the orchestration process 314 may be configured to obtain training schedule data indicated in the model association metadata for a defined association between a machine learning model and an object and trigger training (e.g., retraining) of the corresponding machine learning model based at least in part on the training schedule data. In one example, the training schedule data for the defined association in the model association metadata may include training frequency data specific to the defined association, the training frequency data indicating a frequency at which the machine learning model is to be trained with respect to the defined association. The orchestration process 314 may trigger training (or retraining) of the corresponding machine learning model according to the defined association at the indicated frequency (e.g., in response to determining that a duration of time elapsed since last training of the corresponding machine learning model for the defined association meets or exceeds a predefined training interval of the frequency data). In one example, the orchestration process 314 may trigger the training by generating control signal(s) and/or control message(s) identifying a defined association from the model association metadata for which the training should be performed and transmitting the control signal(s) and/or control message(s) to the training process 308, in response to which the training process 308 executes the training for the identified defined association. In some embodiments, the orchestration process 314 may be configured to obtain the training schedule data and trigger the training based on the training schedule data for each defined association between a machine learning model and an object provided in the model association metadata. Moreover, in some embodiments, the orchestration process 314 may be configured to obtain the training schedule data and trigger the training based on the training schedule data continuously, continually, at predefined periodic intervals, and/or in response to discretely generated commands (e.g., based on input such as user input or API input).

In some embodiments, the orchestration process 314 may be configured to obtain execution schedule data indicated in the model association metadata for a defined association between a machine learning model and an object and trigger execution of the corresponding trained machine learning model based at least in part on the execution schedule data. Additionally or alternatively, the orchestration process 314 may obtain the execution schedule for a trained machine learning model from the trained model metadata associated with the trained machine learning model. In one example, the execution schedule data for a defined association and/or for a trained machine learning model may include execution frequency data specific to the defined association and/or the trained machine learning model, the execution frequency data indicating a frequency at which the corresponding trained machine learning model is to be executed. The orchestration process 314 may trigger execution of the corresponding trained machine learning model at the indicated frequency (e.g., in response to determining that a duration of time elapsed since last execution of the corresponding trained machine learning model meets or exceeds a predefined execution interval of the frequency data). In some embodiments, the orchestration process 314 may be configured to obtain the execution schedule data and trigger the execution based on the execution schedule data for each defined association between a machine learning model and an object provided in the model association metadata. In some embodiments, the orchestration process 314 may be configured to obtain the execution schedule data and trigger the execution based on the execution schedule data for each trained machine learning model registered in the trained model registry 312. Moreover, in some embodiments, the orchestration process 314 may be configured to obtain the execution schedule data and trigger the execution based on the execution schedule data continuously, continually, at predefined periodic intervals, and/or in response to discretely generated commands (e.g., based on input such as user input or API input).

The orchestration process 314 may be configured to invoke (e.g., trigger execution of) the real time execution process 316 for a given trained machine learning model in response to determining that the trained model metadata and/or the model association metadata indicates a real time execution type for the trained model and to invoke the batch execution process 318 for a given trained machine learning model in response to determining that the trained model metadata and/or the model association metadata indicates a batch execution type for the trained model. In another example, the orchestration process 314 may be configured to trigger real time and/or batch execution of the given machine learning model by invoking the real time execution process 316 and/or the batch execution process 318 for a given trained machine learning model at periodic intervals determined based at least in part on the execution schedules provided in the model association metadata and/or trained model metadata for the given trained machine learning model.

In response to being invoked by the orchestration process 314 with respect to a trained machine learning model from the trained model registry 312, the real time execution process 316 of the machine learning platform system 140 may be configured to execute and/or cause real time execution of the trained machine learning model. For example, the real time execution process 316 may execute and/or cause the real time execution of the trained machine learning model by using the trained machine learning model to generate output data associated with an individual, discrete prediction, recommendation, and/or insight task in real time and/or near real time and returning the output data for the individual, discrete prediction, recommendation, and/or insight task directly (e.g., immediately) in response to generation of the output data. Returning the output data resulting from the real time execution may comprise transmitting the output data directly to the enterprise management system 120 (e.g., as part of a web, web app, software-as-a-service (SaaS) or content service operation) in addition to possibly storing the output data in a data repository (e.g., of the one or more data repositories 150) that is accessible to the enterprise management system 120, such as the prediction store 320.

In response to being invoked by the orchestration process 314 with respect to a trained machine learning model from the trained model registry 312, the batch execution process 318 of the machine learning platform system 140 may be configured to execute and/or cause batch execution of the trained machine learning model. For example, the batch execution process 318 may retrieve and/or access an input table containing a plurality of input data sets associated with a plurality of prediction, recommendation, and/or insight tasks to which the trained machine learning model is to be applied. The batch execution process 318 may execute and/or cause the execution of the trained machine learning model based at least in part on the input table to generate output data associated with the plurality of prediction, recommendation, and/or insight tasks and return the output data for the entire set of tasks together. In some embodiments, the batch execution process 318 may be configured to perform the batch execution and return the output data on a periodic basis and/or at periodic intervals (e.g., based on execution schedules indicated in the trained model metadata and/or the model association metadata). Returning the output data resulting from the batch execution may comprise storing the output data for all of the tasks in a data repository (e.g., of the one or more data repositories 150) that is accessible to the enterprise management system 120, such as the prediction store 320 along with possibly generating and/or transmitting a notification to the enterprise management system 120 that the batch execution is complete.

In some embodiments, the orchestration process 314 (e.g., via the batch execution process 318) may be configured to cause batch execution of a given trained machine learning model by generating and/or retrieving updated input data required by the given trained machine learning model, which retrieved updated input data may comprise multiple sets of input data each associated with a different prediction task of the type performed by the given trained machine learning model (e.g., each associated with a different object or set of objects). The orchestration process 314 may provide the retrieved updated input data to the batch execution process 318 (e.g., by overwriting an input table associated with the given trained machine learning model with the retrieved updated input data). In response to receiving the updated input data, the batch execution process 318 may be configured to execute and/or cause execution of the trained machine learning model with respect to the updated input data and store any output data generated via the execution of the trained machine learning model to a data repository (e.g., of the one or more data repositories 150) associated with the prediction store 320.

The prediction store 320 of the machine learning platform system 140 may be a data repository (e.g., of the one or more data repositories) that is configured to store any output data (e.g., predictions, recommendations, insights) generated via the trained machine learning models in the trained model registry 312. The prediction store 320 may allow access to the stored output data to one or more systems for presenting and/or processing said output data, including, for example, the enterprise management system 120. In one example, the prediction store 320 may be associated with a particular enterprise and may be configured to store any and all model output data generated via trained machine learning models (in the trained model registry 312) specifically associated with the particular enterprise, across the particular enterprise.

The enterprise management system 120 may retrieve the output data from the prediction store 320 and present and/or process the retrieved output data, for example, via one or more insight interfaces presented within a GUI rendered on one or more displays of one or more of the user devices 160. In some embodiments, the enterprise management system 120 may be at least partially embodied in a mobile or web application provided as part of an EPM system for monitoring operational systems. The enterprise management system 120 may be configured to provide, for each enterprise, an enterprise-wide, top-to-bottom, historical and/or real-time, view of the status of various processes, assets, people, and/or other objects associated with all of the operational system(s) managed by that enterprise, including any of the output data generated via trained machine learning models associated with the enterprise.

The monitoring process 322 of the machine learning platform system 140 may be configured to monitor execution of the orchestration process 314, the real time execution process 316, and/or the batch execution process 318, including execution of each trained machine learning model of the trained model registry 312, for example, based at least in part on predefined monitoring criteria. In some embodiments, such monitoring comprises determining a level of model drift for a trained machine learning model based at least in part on attributes and/or characteristics associated with the trained machine learning model and/or execution thereof, which may be determined by performing one or more analysis processes with respect to the input data used in each execution of a trained machine learning model, the training data used to train the trained machine learning model, and/or the output data resulting from execution of the trained machine learning model, to name a few examples. In some embodiments, the monitoring process 322 may be configured to determine whether monitored execution of the trained machine learning models indicates a decrease in accuracy and/or precision of the trained machine learning model and, if so, to perform one or more actions to address the decrease in accuracy. For example, in response to determining that a level of model drift associated with a trained machine learning model exceeds a predefined drift threshold (e.g., of the predefined monitoring criteria), the monitoring process 322 may generate a model drift notification associated with the trained machine learning model and cause the model drift notification to be presented on a user device 160 and/or by triggering retraining of the machine learning model by generating one or more control signals and/or control messages and transmitting the control signal(s) and/or message(s) to the training process 308, which may be configured to execute a training process associated with the machine learning model in response to and/or based at least in part on the control signal(s) and/or message(s).

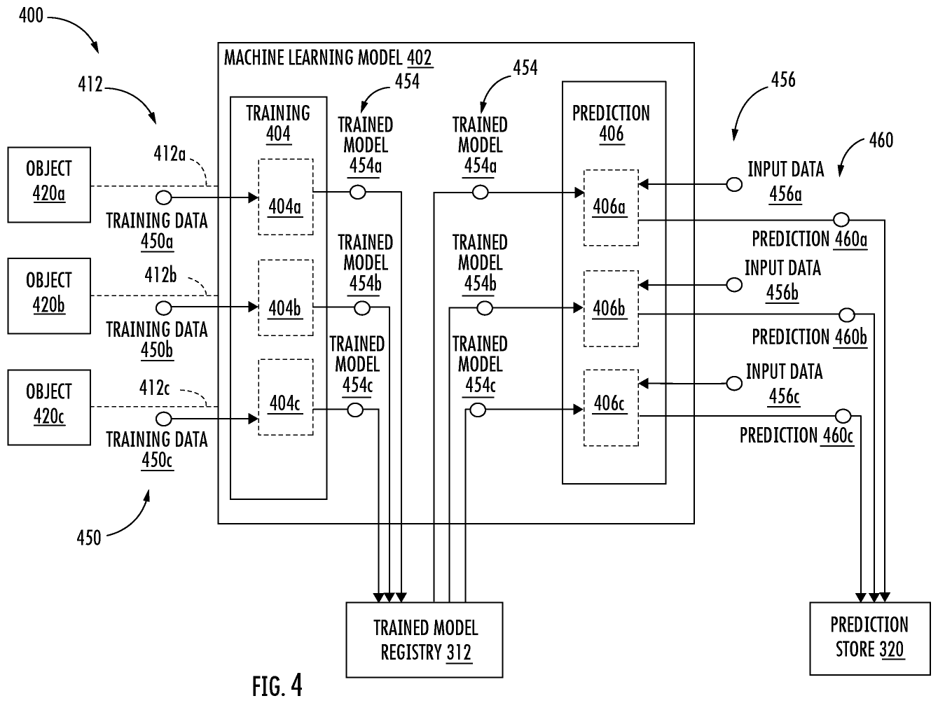

FIG. 4 illustrates a visualization of an example computing environment for training one or more machine learning models and for generating output data (e.g., predictions) using the one or more machine learning models, in accordance with at least some example embodiments of the present disclosure. In this regard, the example computing environments and various data described associated therewith may be maintained by one or more computing devices, such as the machine learning platform system 140 (and/or an apparatus 200 associated therewith). The machine learning platform system 140, and/or apparatuses 200 associated therewith, for example, may be specially configured via hardware, software, firmware, and/or a combination thereof, to perform the various data processing and interactions described with respect to FIG. 4 to generate at least one prediction, for example, including any number predictions.

In various embodiments, the machine learning platform system 140 (and/or an apparatus 200 associated therewith) may be configured to train one or more machine learning models.

In various embodiments, the machine learning platform system 140 (and/or an apparatus 200 associated therewith) may be configured to generate or trigger generation of one or more predictions (e.g., using the one or more machine learning models trained by the machine learning platform system 140).

Accordingly, the example computing environment 400 of FIG. 4 comprises a machine learning model 402, which may be a prediction model for generating one or more prediction(s), for example embodied in one or more predictions 460. In an example embodiment, a machine learning model 402 uses (e.g., as part of a training process 404) training data 450 in order to generate one or more trained models 454, which are configured to generate (e.g., as part of a prediction process 406) predictions 460 with respect to input data 456.

In the illustrated example, the machine learning model 402 is configured based at least in part on a training process 404 and a prediction process 406. In some embodiments, the prediction process 406 is optional, and the model 402 may be trained, stored, and/or transmitted or otherwise provided (e.g., by the machine learning platform system 140) to an entity or system for generating the predictions 460. In some embodiments, the prediction process 406 may trigger execution of one or more external processes for generating the predictions 460 rather than directly generating the predictions 460.

In various embodiments, the machine learning model 402 may undergo a training process (e.g., represented by the training process 404) using a training data set (e.g., represented by training data 450) in order to identify features and to determine optimal coefficients representing adjustment or weights to apply with respect to the features in order to produce a target prediction reflected in the training data set, for example, based on positive and/or negative correlations between extracted features from the training data set and training labels and/or training values from the training data set or other extracted features from the training data set. The machine learning model 402 may comprise a data object created by using machine learning to learn to perform a given function (e.g., a prediction) through training with the training data set. For example, the training process 404 may formulate a mapping function ƒ from input variables x to discrete output variables y. The machine learning model 402 may be trained to generate a prediction, for example embodied in the predictions 460, by learning from the training data set.

In various embodiments, the training data 450 input into the machine learning model 402 at the training process 404 may comprise operational data and/or operational system context data associated with and/or collected from the one or more operational systems 110. The training data 450, including any of the operational data and/or operational system context data of the training data 450, may comprise one or more training labels, training tags, and/or training values, which may represent known attributes that correspond to and/or are analogous to the attributes that the machine learning model 402 is configured to predict with respect to the input data 456.

In one example, the training process 404 may formulate a mapping function ƒ from input variables x to discrete output variables y, with the input variables x each representing features extracted from the training data 450. For example, based at least in part on the training process 404, the machine learning model 402 may be configured to express a prediction using a function ƒ(x₁, x₂, . . . , xₚ), where x₁, x₂, . . . , xₚ are features, quantities, values, and/or metrics extracted, calculated, and/or determined from the training data 450. In particular, the features, quantities, values, and/or metrics extracted, calculated, and/or determined from the training data 450 may represent and/or correspond to attributes (e.g., values, quantities) reflected in the training data 450 with respect to a particular data item associated with the prediction being generated. The mapping function and/or any trained model weights formulated via the training process 404 may be based at least in part on correlations between the features, quantities, values, and/or metrics extracted, calculated, and/or determined from the training data 450. The training process 404 may comprise determining these correlations and/or any other relationships between the various features of the training data 450 and configuring and/or training the machine learning model 402 based at least in part on the determined correlations and/or relationships.

In some embodiments, the training data 450 may be input into the training process 404 of the machine learning model 402 to train the model to generate the predictions 460. A product of the model training are trained models 454 that are used by the prediction process 406 of the machine learning model 402. In some embodiments, after an initial training, further training data may be input to the training process 404 of the machine learning model 402, periodically or on an on-going basis, to refine and update the model.

In various embodiments, the trained models 454 output by the training process 404 may comprise trained model weights to apply to features or variables from the input data 456, and/or to any operations performed with respect to the features or variables from the input data 456. Each trained model 454 and/or any trained model weights thereof may be embodied in and/or comprise a trained model artifact representing the trained model 454 and/or trained model metadata associated with the trained model 454.

In various embodiments, the machine learning platform system 140 may be configured to register each trained model 454 in the trained model registry 312, which may include storing any data objects representing the trained model 454 (e.g., trained model artifact, trained model metadata) in a data repository (e.g., of the one or more data repositories 150) associated with the trained model registry. The trained models 454 registered in the trained model registry 312 may be accessible to the prediction process 406 and/or any external processes and/or systems configured to generate the predictions 460 using the trained models 454.

The machine learning model 402 may be trained to generate a prediction, for example embodied in the predictions 460, via the prediction process 406 based at least in part on input data 456. In various embodiments, the input data 456 input into the machine learning model 402 at the prediction process 406 may comprise operational data and/or operational system context data associated with and/or collected from the one or more operational systems 110. In one example, the input data 456 may comprise some or all of the features of the training data 450, including those features used to generate the prediction. The input data 456 may be associated with a different period of time than that of the training data 450 and/or may be associated with a different set of objects (associated with the operational systems 110) than that of the training data 450. In one example, the training data 456 for a machine learning model 402 may comprise a particular set of features of operational data associated with a particular set of objects and collected from the operational system(s) 110 over a first period of time, while the input data 456 for the machine learning model 402 may comprise the same set of features of operational data associated with the same set of objects but collected from the operational system(s) 110 over a second period of time that is subsequent to the first period of time. In another example, the training data 456 for a machine learning model 402 may comprise a particular set of features of operational data associated with a first set of objects of a particular type, while the input data 456 for the machine learning model 402 may comprise the same set of features as that of the training data 456 of operational data but associated with a second set of objects of the same type as that of the training data 456.

In some embodiments, the input data 456 is input into the prediction process 406 of the machine learning model 402 along with the trained model 454 with which the input data 456 is associated. The prediction process 406 may be configured to retrieve the trained model 454 from the trained model registry 312 (e.g., by retrieving the trained model artifact and/or trained model metadata from a data repository associated with the trained model registry 312). The prediction process 406 may be configured to retrieve the input data 456 from one or more data repositories 150 (e.g., by retrieving operational data identified by and/or associated with the trained model 454).

Upon receiving the input data 456, the prediction process 406 of the machine learning model 402 outputs the predictions 460. The predictions 460 output by the prediction process 406 may be generated by the prediction process 406 based at least in part on the trained model 454 (e.g., trained model artifact, trained model metadata) and the input data 456 (e.g., operational data). The machine learning platform system 140 and/or the prediction process may be configured to retain each prediction 460 in a prediction store 320, which may include storing any data objects representing the prediction 460 in a data repository (e.g., of the one or more data repositories 150) associated with the prediction store 320. The predictions 460 in the prediction store 320 may be accessible to other processes and/or components of the machine learning platform system 140 and/or to external processes and/or systems such as the enterprise management system 120.

As previously described, the machine learning platform system 140 may be configured to generate (e.g., via the association process 304) model association metadata pertaining to the machine learning model 402. The model association metadata may comprise defined associations 412 between the machine learning model 402 and one or more objects 420 associated with the one or more operational systems 110. In the illustrated example, the model association metadata comprises a first defined association 412a between a first object 420a and the machine learning model 402, a second defined association 412b between a second object 420b and the machine learning model 402, and a third defined association 412c between a third object 420c and the machine learning model 402.

With respect to a particular machine learning model (such as the machine learning model 402) configured for a particular type of prediction task, the machine learning platform system 140 may be configured to perform different training and prediction processes that are determined based on and/or specific to each defined association 412 of the model association metadata.

In various embodiments, for a given defined association 412, the machine learning platform system 140 may be configured to retrieve a distinct set of training data 450 that is determined by, associated with, and/or specific to the given defined association 412, execute a distinct instance of the training process 404 that is associated with, and/or specific to the given defined association, with the distinct instance of the training process 404 using the distinct set of training data 450 to generate a distinct trained model 454 that is associated with and/or specific to the given association 412.

For example, a given defined association 412 may establish an association between a particular object 420 (associated with the one or more operational systems 110) and a machine learning model 402. By virtue of the given defined association 412 being indicated in the model association metadata, the machine learning platform system 140 may be configured to retrieve a set of training data 450 comprising data that is specifically associated with the particular object 420 of the defined association 412 (e.g., operational data collected from and/or associated with the particular object 420, operational data collected from and/or associated with objects of the same type as the particular object 420). The machine learning platform system 140 may be configured to initiate an instance of the training process 404 specific to the defined association 412, which may generate a trained model 454 based at least in part on the set of training data 450 associated with the particular object 420 using a model training pipeline associated with the machine learning model 402 (e.g., in the model configuration data). The distinct trained model 454 may then be used to perform a prediction task associated with the machine learning model 402 specifically with respect to the particular object 420, by generating a prediction 460 specifically associated with the defined association 412 and/or the particular object 420 corresponding to the defined association 412.

In the illustrated example, a machine learning model 402 represents a particular prediction task or type thereof. A first object 420a, a second object 420b, and a third object 420c are all associated with the machine learning model 402, as the model association metadata comprises a first defined association 412a establishing an association between the first object 420a and the machine learning model 402, a second defined association 412b establishing an association between the second object 420b and the machine learning model 402, and a third defined association 412c establishing an association between the third object 420c and the machine learning model 402. The machine learning platform system 140 executes a first training process 404a corresponding to the first defined association 412a, a second training process 404b corresponding to the second defined association 412b, and a third training process 404c corresponding to the third defined association 412c. The first training process 404a generates a first trained model 454a configured to perform the prediction task represented by the machine learning model 402 specifically with respect to the first object 420a and/or the first defined association 412a. The second training process 404b generates a second trained model 454b configured to perform the prediction task represented by the machine learning model 402 specifically with respect to the second object 420b and/or the second defined association 412b. The third training process 404c generates a third trained model 454c configured to perform the prediction task represented by the machine learning model 402 specifically with respect to the third object 420c and/or the third defined association 412c. The machine learning platform system 140 executes a first prediction process 406a corresponding to the first defined association 412a, a second prediction process 406b corresponding to the second defined association 412b, and a third prediction process 406c corresponding to the third defined association 412c. The first prediction process 406a uses the first trained model 454a to generate a first prediction 460a, which represents a result of performing the prediction task represented by the machine learning model 402 specifically with respect to the first object 420a and/or the first defined association 412a. The second prediction process 406b uses the second trained model 454b to generate a second prediction 460b, which represents a result of performing the prediction task represented by the machine learning model 402 specifically with respect to the second object 420b and/or the second defined association 412b. The third prediction process 406c uses the third trained model 454c to generate a third prediction 460c, which represents a result of performing the prediction task represented by the machine learning model 402 specifically with respect to the third object 420c and/or the third defined association 412c.

In various embodiments, the machine learning platform system 140 may be configured to retrieve a distinct set of training data 450 (e.g., defined by, determined by, and/or based on model training pipeline data associated with the machine learning model 402 in the model configuration data) for each defined association 412 indicated in the model association metadata. In the illustrated example, the machine learning platform system 140 retrieves a first set of training data 450a specific to the first training process 404a based at least in part on the first defined association 412a, for example, by retrieving a set of operational data comprising particular features and/or types of data (e.g., defined via the model training pipeline for the machine learning model 402) having values specific to the first object 420a and inputting the retrieved operational data into the first training process 404a as the first set of training data 450a. The machine learning platform system 140 retrieves a second set of training data 450b specific to the second training process 404b based at least in part on the second defined association 412b, for example, by retrieving a set of operational data comprising the same particular features and/or types of data as that of the first training process 404a but having values specific to the second object 420b and inputting the retrieved operational data into the second training process 404b as the second set of training data 450b. The machine learning platform system 140 retrieves a third set of training data 450c specific to the third training process 404c based at least in part on the third defined association 412c, for example, by retrieving a set of operational data comprising the same particular features and/or types of data as that of the first training process 404a and second training process 404b but having values specific to the third object 420c and inputting the retrieved operational data into the third training process 404c as the third set of training data 450c. Each of the three training processes 404a, 404b, 404c may execute a common set of data processing and/or training operations (e.g., defined by, determined by, and/or based on model training pipeline data associated with the machine learning model 402 in the model configuration data) with respect to a different set of training data, namely the first set of training data 450a, the second set of training data 450b, and the third set of training data 450c, respectively.

In various embodiments, the machine learning platform system 140 may be configured to retrieve a distinct set of input data 456 for each defined association 412 indicated in the model association metadata. In the illustrated example, the machine learning platform system 140 retrieves a first set of input data 456a specific to the first prediction process 406a based at least in part on the first defined association 412a, for example, by retrieving a set of operational data comprising particular features and/or types of data (e.g., defined via the model configuration data and/or trained model 454) having values specific to the first object 420a and inputting the retrieved operational data into the first prediction process 406a as the first set of input data 456a. The machine learning platform system 140 retrieves a second set of input data 456b specific to the second prediction process 406b based at least in part on the second defined association 412b, for example, by retrieving a set of operational data comprising the same particular features and/or types of data as that of the first prediction process 406a but having values specific to the second object 420b and inputting the retrieved operational data into the second prediction process 406b as the second set of input data 456b. The machine learning platform system 140 retrieves a third set of input data 456c specific to the third prediction process 406c based at least in part on the third defined association 412c, for example, by retrieving a set of operational data comprising the same particular features and/or types of data as that of the first prediction process 406a and second prediction process 406b but having values specific to the third object 420c and inputting the retrieved operational data into the third prediction process 406c as the third set of training data 456c. Each of the three prediction processes 406a, 406b, 406c may execute a common set of data processing and/or prediction operations (e.g., defined by, determined by, and/or based on the model configuration data) using different trained model weights and/or other parameters (e.g., respectively defined by, determined by, and/or based on the trained model 454 corresponding to the particular prediction process) with respect to a different set of input data, namely the first set of input data 456a, the second set of input data 456b, and the third set of input data 456c, respectively.

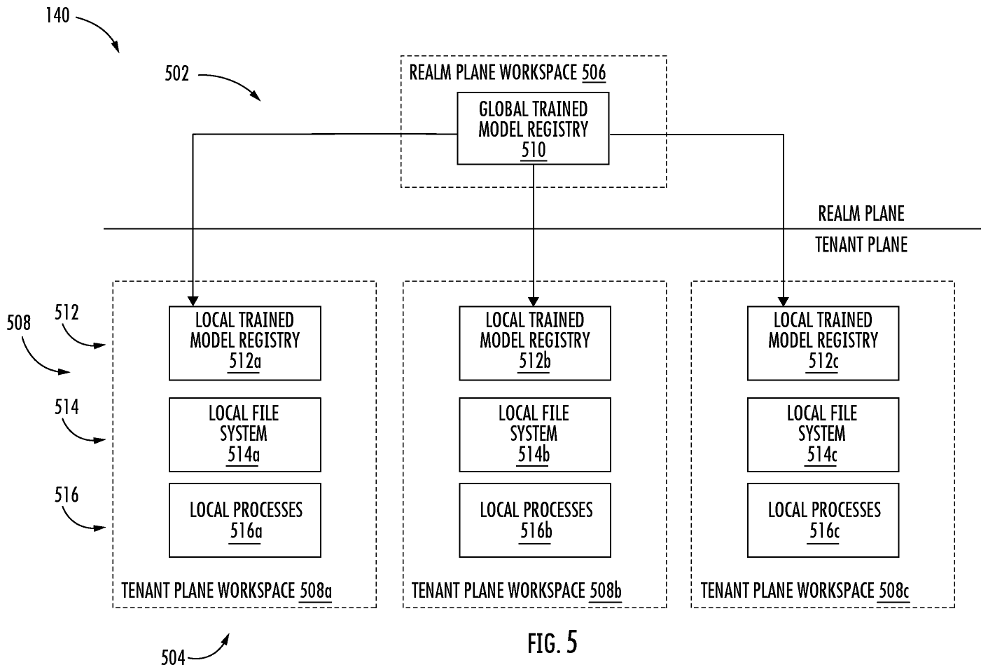

FIG. 5 is an illustration of an example machine learning platform system 140, in accordance with at least some example embodiments of the present disclosure. Specifically, FIG. 5 includes schematic depictions of example internal processes and components of the machine learning platform system 140 according to a distributed configuration for the machine learning platform system 140. In the illustrated example, the distributed configuration for the machine learning platform system 140 comprises a realm plane 502 and a tenant plane 504.

In various embodiments, the realm plane 502 may represent a global repository for all machine learning models maintained by the machine learning platform system 140, including machine learning models that may be associated with and/or potentially provided to and used by a plurality of different enterprises. In the illustrated example, the realm plane 502 comprises a realm plane workspace 506.

In some examples, the tenant plane 504 may represent a distribution of the machine learning models maintained by the machine learning platform system 140 across a plurality of different tenants, which may represent discrete entities for which different instances or variations of the functionality and/or components of the machine learning platform system 140 may be provided along with access to some or all of the machine learning models maintained by the machine learning platform system 140 (e.g., at the realm plane 502). In one example, the tenants of the tenant plane 504 may represent different enterprises subscribed to the machine learning platform system 140 and the functionality provided thereby. In the illustrated example, the tenant plane 504 comprises a plurality of tenant plane workspaces 508.

The realm plane workspace 506 may represent a computing environment for configuring, associating, training, registering, and distributing (e.g., to the various tenants) the machine learning models maintained by the machine learning platform system 140. In some embodiments, the realm plane workspace 506 may correspond to a workspace object implemented via a cloud computing platform such as Microsoft Azure operated by Microsoft Corporation. The realm plane workspace 506 may comprise a global instance of any of the processes and/or components previously defined and described with respect to FIG. 3, including, for example, a global instance of the configuration process 302, a global instance of the association process 304, a global instance of the training process 308, a global instance of the feature store 310, and/or a global instance of the trained model registry 312, to name a few examples. In the illustrated example, the realm plane workspace 506 comprises a global trained model registry 510.

The global trained model registry 510 may be an instance of a trained model registry as previously defined and described, such as the trained model registry 312 depicted in FIG. 3. More particularly, however, the global trained model registry 510 stores a global set of trained machine learning models that may be imported and/or accessed by different tenants in the tenant plane 504. In one example, each machine learning model in the global set of trained machine learning models stored by the global trained model registry 510 may represent a generic version of a trained machine learning model (e.g., associated with a particular prediction task) that may be initially trained (e.g., using operational data and/or operational system context data available to and/or maintained within the realm plane workspace 506) at the realm plane 502, distributed to different tenants in the tenant plane 504, and further customized, modified, fine-tuned, and/or retrained at the tenant plane 504.

Each tenant plane workspace 508 of the tenant plane 504 may represent a contained computing environment for configuring, associating, training, registering, executing, and monitoring a local set of machine learning models maintained by the machine learning platform system 140 specifically with respect to a tenant associated with the tenant plane workspace 508. In some embodiments, the tenant plane workspace 508 may correspond to a workspace object implemented via a cloud computing platform such as Microsoft Azure operated by Microsoft Corporation. The tenant plane workspace 508 and various components thereof may have a local scope relative to the realm plane workspace 506 by virtue of being self-contained and/or having access to data and/or functionality that is restricted to that contained within the particular tenant plane workspace 508 or inherited from the realm plane workspace 506. The tenant plane workspace 508 may comprise a local instance of any of the processes and/or components previously defined and described with respect to FIG. 3, including, for example, a local instance of the configuration process 302, a local instance of the association process 304, a local instance of the training process 308, a local instance of the feature store 310, a local instance of the trained model registry 312, a local instance of the orchestration process 314, a local instance of the real time execution process 316, a local instance of the batch execution process 318, and/or a local instance of the prediction store 320, to name a few examples. In the illustrated example, each tenant plane workspace 508 comprises a local trained model registry 512, a local file system 514, and a series of local processes 516.

Each local trained model registry 512 may be an instance of a trained model registry as previously defined and described, such as the trained model registry 312 depicted in FIG. 3. More particularly, however, the local trained model registry 512 stores a local set of trained machine learning models that may be accessed and/or used only within the tenant plane workspace 508. In various embodiments, the local set of trained machine learning models stored by the local trained model registry 512 may include generic versions of trained machine learning models (e.g., inherited from the realm plane workspace 506), customized, modified, fine-tuned, and/or retrained versions of trained machine learning models received from the realm plane workspace 506, and/or machine learning models developed, configured, and/or trained within the tenant plane workspace 508.

Each local file system 514 may provide access to portions of the one or more data repositories 150 that are specifically associated with the tenant plane workspace 508, including local instances of the feature store 310, the trained model registry 312 (e.g., the local trained model registry 512), and/or the prediction store 320. The data controlled via the local file system 514 may be restricted such that the local file system 514 may only be accessed from the tenant plane workspace 508 containing the local file system 514.

The local processes 516 of each tenant plane workspace 508 may correspond to various processes for implementing the functionality of the machine learning platform system 140 as previously described. For example, the local processes 516 of the tenant plane workspace 508 may include local instances of the configuration process 302, the association process 304, the training process 308, the orchestration process 314, the real time execution process 316, and/or the batch execution process 318. The local processes 516 may perform the same functionality as those previously described with respect to FIG. 3 but with access by the processes restricted only to the data and/or other processes contained within the tenant plane workspace 508.

In the illustrated example, the tenant plane 504 includes a first tenant plane workspace 508a, a second tenant plane workspace 508b, and a third tenant plane workspace 508c. The first tenant plane workspace 508a comprises a first local trained model registry 512a, a first local file system 514a, and a first set of local processes 516a. The second tenant plane workspace 508b comprises a second local trained model registry 512b, a second local file system 514b, and a second set of local processes 516b. The third tenant plane workspace 508c comprises a third local trained model registry 512c, a third local file system 514c, and a third set of local processes 516c. The different local trained model registries 512a, 512b, 512c each inherit trained machine learning models from the global trained model registry 510 of the realm plane workspace 506, which inherited models may be customized, modified, fine-tuned, retrained, executed, and/or monitored (e.g., in different ways) within each different tenant plane workspace 508a, 508b, 508c via the respective local processes 516a, 516b, 516c with respect to different training data sets and/or input data sets stored in the respective local file systems 514a, 514b, 514c.

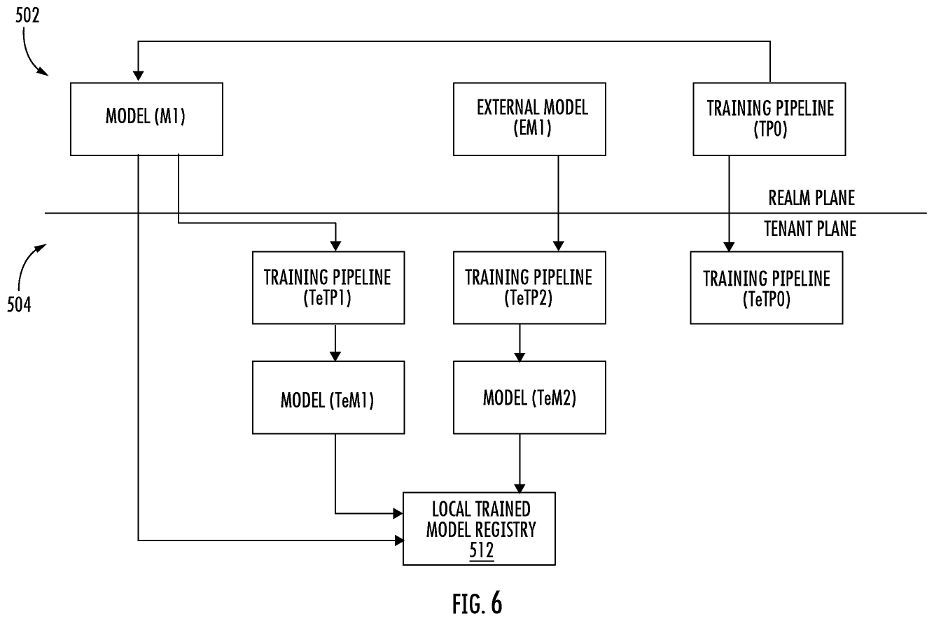

FIG. 6 is an illustration of an example machine learning platform system 140 having a distributed configuration, in accordance with at least some example embodiments of the present disclosure. Specifically, FIG. 6 is an illustration of inheritance between the tenant plane 504 and the realm plane 502 with reference to schematic depictions of example machine learning models, training pipelines, and components of the machine learning platform system 140.

In the illustrated example, the realm plane 502 comprises a machine learning model M1, an external machine learning model EM1, and a training pipeline TP0, and the tenant plane comprises a first tenant plane training pipeline TeTP1, a second tenant plane training pipeline TeTP2, an inherited tenant plane training pipeline TeTP0, a first tenant plane machine learning model TeM1, a second tenant plane machine learning model TeM2, and one or more local trained model registries 512.

The machine learning model M1 may represent a trained machine learning model configured and trained at the realm plane 502, for example, via the various training processes previously defined and described with respect to FIGS. 3 and 4.

The external machine learning model EM1 may represent a machine learning model imported by the machine learning platform system 140 (e.g., from an external service or provider of machine learning models).

The training pipeline TP0 may refer to a model training pipeline such as those previously described with respect to the machine learning platform system 140 and/or the model training pipeline data thereof. More particularly, the training pipeline TP0 may define one or more operations for processing a given data set, training a given machine learning model, and/or generating a trained machine learning model based on the given data set and given machine learning model.

In one example, the training pipeline TP0 may be executed (e.g., at the realm plane 502) with respect to the machine learning model M1 in order to produce a trained machine learning model corresponding to the machine learning model M1, which trained model may be directly inherited by one or more tenant plane workspaces 508 and, for example, registered in the local trained model registry 512 of each of the tenant plane workspaces 508 inheriting the model.

In another example, the machine learning model M1 may be inherited by a particular tenant plane workspace 508, and the first tenant plane training pipeline TeTP1 of the particular tenant plane workspace 508 may be executed (e.g., at the tenant plane 508) with respect to the machine learning model M1 in order to produce a trained machine learning model corresponding to the machine learning model M1, namely the first tenant plane machine learning model TeM1. The first tenant plane machine learning model TeM1 may be registered in the local trained model registry 512 of the tenant plane workspace 508 containing the tenant plane training pipeline TeTP1 that produced the model TeM1.

In another example, external machine learning model EM1 may be imported by the machine learning platform system 140 at the realm plane 502 (and inherited by one or more tenant plane workspaces 508) or imported at the tenant plane 504. The second tenant plane training pipeline TeTP2 of a particular tenant plane workspace 508 that inherited or imported the external machine learning model EM1 may be executed (e.g., at the tenant plane 508) with respect to the external machine learning model EM1 in order to produce a trained machine learning model corresponding to the external machine learning model EM1, namely the second tenant plane machine learning model TeM2. The second tenant plane machine learning model TeM2 may be registered in the local trained model registry 512 of the tenant plane workspace 508 containing the tenant plane training pipeline TeTP2 that produced the model TeM2.

In yet another example, the training pipeline TP0 may itself be inherited from the realm plane 502 by one or more tenant plane workspaces 508 and executed within the one or more tenant plane workspaces 508 that inherited the training pipeline TP0.

Having described example systems and/or apparatuses of the present disclosure, example flowcharts including various operations performed by the apparatuses and/or systems described herein will now be discussed. It should be appreciated that each of the flowcharts depicts an example computer-implemented process that may be performed by one or more of the apparatuses, systems, and/or devices described herein, for example utilizing one or more of the components thereof. The blocks indicating operations of each process may be arranged in any of a number of ways, as depicted and described herein. In some such embodiments, one or more blocks of any of the processes described herein occur in-between one or more blocks of another process, before one or more blocks of another process, and/or otherwise operates as a sun-process of a second process. Additionally or alternatively, any of the processes may include some or all of the steps described and/or depicted, including one or more optional operational blocks in some embodiments. With respect to the flowcharts discussed below, one or more of the depicted blocks may be optional in some, or all, embodiments of the disclosure. Similarly, it should be appreciated that one or more of the operations of each flowchart may be combinable, replaceable, and/or otherwise altered as described herein.

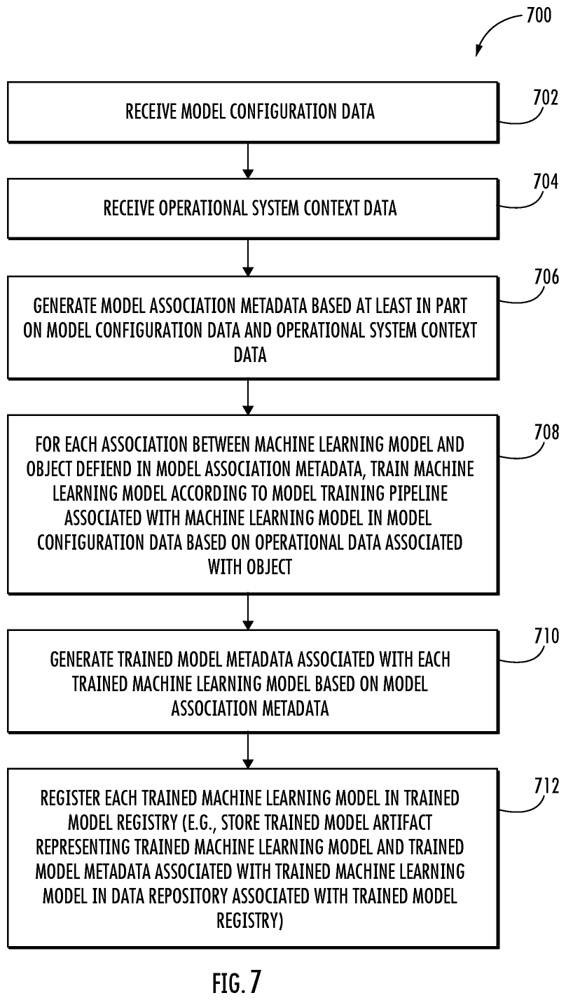

FIGS. 7-10 illustrate flowcharts including operational blocks of example processes in accordance with at least some example embodiments of the present disclosure. In some embodiments, the computer-implemented processes of FIGS. 7-10 are each embodied by computer program code stored on a non-transitory computer-readable medium of a computer program product configured for execution to perform the computer-implemented method. Alternatively or additionally, in some embodiments, the example processes of FIGS. 7-10 are performed by one or more specially configured computing devices, such as the specially configured apparatus 200 (e.g., via data intake circuitry 212, AI and machine learning circuitry 210, association circuitry 214, access control circuitry 218, and/or monitoring circuitry 216). In this regard, in some such embodiments, the apparatus 200 is specially configured by computer program instructions stored thereon, for example in the memory 204 and/or another component depicted and/or described herein, and/or otherwise accessible to the apparatus 200, for performing the operations as depicted and described with respect to the example processes of FIGS. 7-10. In some embodiments, the specially configured apparatus 200 includes and/or otherwise is in communication with one or more external apparatuses, systems, devices, and/or the like, to perform one or more of the operations as depicted and described. While the operational blocks of each of the example processes are depicted in each of FIGS. 7-10 in a particular order, this should not be understood as requiring that such operations be performed in the particular order shown or in sequential order, or that all illustrated operations be performed.

FIG. 7 illustrates a flowchart including operational blocks of an example process 700 for developing, configuring, training, and/or deploying one or more machine learning models for generating insights, predictions, and/or recommendations associated with the one or more operational systems 110, in accordance with at least some example embodiments of the present disclosure.

The process 700 begins at operation 702, at which an apparatus (such as, but not limited to, the apparatus 200 or circuitry thereof as described above in connection with FIG. 2) receives model configuration data. In various embodiments, the model configuration data identifies one or more machine learning models and a model training pipeline associated with each of the one or more machine learning models. Operation 702 may comprise some or all of the functionality attributed to the configuration process 302 as described with respect to FIG. 3, and the model configuration data may be as defined and described with respect to FIG. 3, for example.

At operation 704 of the process 700, an apparatus (such as, but not limited to, the apparatus 200 or circuitry thereof described above in connection with FIG. 2) receives operational system context data. In various embodiments, the operational system context data may identify one or more objects associated with the one or more operational systems 110. The operational system context data may be as defined and described with respect to FIG. 1, in one example. Additionally or alternatively, operation 704 may comprise some or all of the functionality attributed to the data intake circuitry 212 as described with respect to FIG. 2. Additionally or alternatively, operation 704 may comprise some or all of the functionality attributed to the association process 304 as described with respect to FIG. 3, and the operational system context data may comprise the extensible object model 306 as defined and described with respect to FIG. 3.

At operation 706 of the process 700, an apparatus (such as, but not limited to, the apparatus 200 or circuitry thereof described above in connection with FIG. 2) generates model association metadata based at least in part on the model configuration data (received at operation 702) and the operational system context data (received at operation 704). In various embodiments, the model association metadata defines associations between the one or more machine learning models (e.g., identified in the model configuration data) and the one or more objects associated with the one or more operational systems 110 (e.g., identified in the operational system context data). The model association metadata generated at operation 706 may comprise model training parameters, model deployment parameters, and/or model execution parameters corresponding to one or more of the defined associations included in the model association metadata. The model association metadata generated at operation 706 may be as defined and described with respect to FIG. 1, in one example. Additionally or alternatively, operation 706 may comprise some or all of the functionality attributed to the association process 304 as described with respect to FIG. 3, and the model association metadata generated at operation 706 may be model association metadata as defined and described with respect to FIG. 3. Additionally or alternatively, the model association metadata generated at operation 706 may be model association metadata as defined and described with respect to FIG. 4, and the associations between the one or more machine learning models and the one or more objects may be embodied in the defined associations 412 depicted and described with respect to FIG. 4.

At operation 708 of the process 700, an apparatus (such as, but not limited to, the apparatus 200 or circuitry thereof described above in connection with FIG. 2), for each association (of the associations defined by the model association metadata generated at operation 706) between a particular machine learning model and a particular object, trains the particular machine learning model according to the model training pipeline associated with the particular machine learning model (in the model configuration data received at operation 702) based at least in part on operational data associated with the particular object. Operation 708 may comprise some or all of the functionality attributed to the training process 308 as described with respect to FIG. 3, for example. Additionally or alternatively, operation 708 may comprise some or all of the functionality attributed to any of the training processes 404 defined and described with respect to FIG. 4. Additionally or alternatively, the operational data used at operation 708 may comprise, may be a subset of, and/or may be the operational data as defined and described with respect to FIG. 1. Additionally or alternatively, the operational data used at operation 708 may comprise, may be part of, and/or may correspond to any of the sets of training data 450 described with respect to FIG. 4.

At operation 710 of the process 700, an apparatus (such as, but not limited to, the apparatus 200 or circuitry thereof described above in connection with FIG. 2), for each trained machine learning model (trained at operation 708), generates trained model metadata associated with the trained machine learning model based at least in part on the model association metadata (generated at operation 706). In various embodiments, the trained model metadata (generated at operation 710) for each trained machine learning model may comprise an indication of whether the trained machine learning model is to be deployed, an execution schedule for the trained machine learning model, one or more execution types associated with the trained machine learning model (e.g., real time execution, batch execution), and/or one or more deployment endpoints associated with the trained machine learning model. Operation 710 may comprise some or all of the functionality attributed to the training process 308 as described with respect to FIG. 3, and the trained model metadata may be as defined and described with respect to FIG. 3, comprising one or more execution types associated with the trained machine learning model, model deployment parameters associated with the trained machine learning model, and/or an execution schedule associated with the trained machine learning model, for example. Additionally or alternatively, the trained machine learning model(s) referred to with respect to operation 710 may correspond to any of the trained models 454 as defined and described with respect to FIG. 4, and the trained model metadata generated at operation 710 may represent any of the trained models 454 as defined and described with respect to FIG. 4.

At operation 712 of the process 700, an apparatus (such as, but not limited to, the apparatus 200 or circuitry thereof described above in connection with FIG. 2), for each trained machine learning model (trained at operation 708), registers the trained machine learning model in a trained model registry. In various embodiments, registering the trained machine learning model in the trained model registry may comprise storing a trained model artifact representing the trained machine learning model and the trained model metadata (generated at operation 710) associated with the trained machine learning model in a data repository (e.g., of the one or more data repositories 150) associated with the trained model registry. Operation 712 may comprise some or all of the functionality attributed to the training process 308 as described with respect to FIG. 3, the trained model artifact generated at operation 712 may be as defined and described with respect to FIG. 3, and/or the trained model registry referred to with respect to operation 712 may correspond to the trained model registry 312 defined and described with respect to FIGS. 3 and 4, for example. Additionally or alternatively, the trained machine learning model(s) referred to with respect to operation 712 may correspond to any of the trained models 454 as defined and described with respect to FIG. 4 and/or may correspond to the machine learning models M1, TeM1, TeM2 defined and described with respect to FIG. 6. Additionally or alternatively, the trained model registry referred to with respect to operation 712 may correspond to the global trained model registry 510 and/or any of the local trained model registries 512 defined and described with respect to FIGS. 5 and 6.

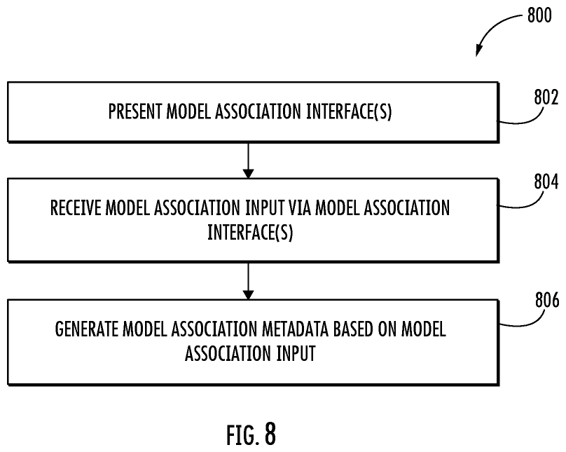

FIG. 8 illustrates a flowchart including operational blocks of an example process 800 for generating model association metadata, in accordance with at least some example embodiments of the present disclosure.

The process 800 begins at operation 802, at which an apparatus (such as, but not limited to, the apparatus 200 or circuitry thereof as described above in connection with FIG. 2) presents one or more model association interfaces configured to receive model association input. Operation 802 may comprise functionality attributed to the association process 304 as described with respect to FIG. 3, and the one or more model association interfaces presented at operation 802 may correspond to the one or more model association interfaces presented by the association process 304. For example, presenting the one or more model association interfaces at operation 802 may comprise presenting a model association user interface (of the one or more model association interfaces) within a GUI rendered on one or more displays of one or more of the user devices 160 and/or exposing an API (of the one or more model association interfaces) configured to receive the model association input.

At operation 804 of the process 800, an apparatus (such as, but not limited to, the apparatus 200 or circuitry thereof described above in connection with FIG. 2) receives model association input via the one or more model association interfaces (presented at operation 802). Operation 804 may comprise functionality attributed to the association process 304 as described with respect to FIG. 3, and the model association input received at operation 804 may be as defined and described with respect to FIG. 3. For example, receiving the model association input at operation 804 may comprise generating the model association input based at least in part on detecting interactions between the one or more model association interfaces (e.g., presented within a GUI) and an association user (such as the association user 350a described with respect to FIG. 3), which may be a technician and/or engineer tasked with maintenance and/or configuration of one or more particular operational systems (of the one or more operational systems 110). In another example, receiving the model association input at operation 804 may comprise receiving and/or processing calls to an API (of the one or more model association interfaces) from one or more computing devices associated with the registration user 350b and generating the model association input based at least in part on the received and/or processed requests (e.g., generating the model association input to include data provided as part of or in conjunction with the API calls).

At operation 806 of the process 800, an apparatus (such as, but not limited to, the apparatus 200 or circuitry thereof described above in connection with FIG. 2) generates the model association metadata based at least in part on the model association input (received at operation 804). In various embodiments, the model association metadata may be generated at operation 806 based at least in part on model configuration data and/or operational system context data in addition to the model association input. Additionally, generating the model association metadata at operation 806 may correspond with and/or may be an example of and/or included as part of generating the model association metadata at operation 706 as described with respect to process 700 of FIG. 7. Accordingly, the model association metadata generated at operation 806 may be as defined and described with respect to operations 706, 708, and/or 710 of the process 700 of FIG. 7.

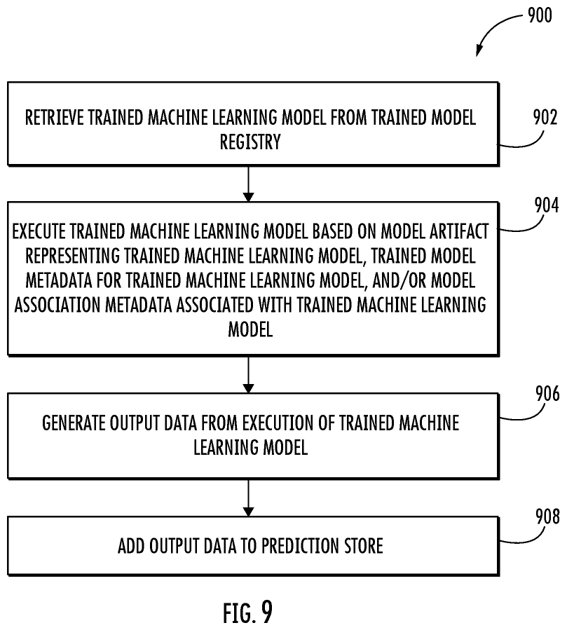

FIG. 9 illustrates a flowchart including operational blocks of an example process 900 for executing and/or causing execution of one or more machine learning models, in accordance with at least some example embodiments of the present disclosure.

The process 900 begins at operation 902, at which an apparatus (such as, but not limited to, the apparatus 200 or circuitry thereof as described above in connection with FIG. 2) retrieves a trained machine learning model from a trained model registry. In various embodiments, operation 902 (and the other operations of process 900) may be performed for each trained machine learning model registered in the trained model registry. Retrieving the trained machine learning model at operation 902 may comprise accessing and/or retrieving from a data repository (e.g., of the one or more data repositories 150) associated with the trained model registry a trained model artifact and/or trained model metadata representing the trained machine learning model. Operation 902 may comprise any of the functionality attributed to the orchestration process 314 as described with respect to FIG. 3, including monitoring the trained model registry to detect addition of newly trained models to the registry and/or deploying the trained machine learning model according to any of the deployment operations defined and/or described with respect to FIG. 3, for example. Additionally or alternatively, the trained model registry referred to with respect to operation 902 may correspond to the trained model registry (and any examples thereof) defined and described with respect to operation 712 of the process 700 of FIG. 7. Additionally or alternatively, trained machine learning models registered in the trained model registry, including that retrieved at operation 902, may correspond to machine learning models that have been configured, trained, and/or registered according to some or all of the functionality defined and described with respect to the process 700 of FIG. 7 and/or the process 800 of FIG. 8. Additionally or alternatively, operation 902 may comprise functionality attributed to the prediction process 406 as defined and described with respect to FIG. 4, and the trained machine learning models registered in the trained model registry, including that retrieved at operation 902, may correspond to any of the trained models 454 as defined and described with respect to FIG. 4.

At operation 904 of the process 900, an apparatus (such as, but not limited to, the apparatus 200 or circuitry thereof described above in connection with FIG. 2) executes the trained machine learning model (retrieved at operation 902) based at least in part on a model artifact representing the trained machine learning model, trained model metadata associated with the trained machine learning model, and/or model association metadata associated with the trained machine learning model. Operation 904 may comprise retrieving a set of input data associated with the trained machine learning model (e.g., operational data associated with a particular object that is associated with the trained machine learning model in the model association metadata) and executing the trained machine learning model with respect to the retrieved input data, for example. Operation 904 may comprise the functionality attributed to the orchestration process 314, real time execution process 316, and/or batch execution process 318, as described with respect to FIG. 3, including deploying the trained machine learning model, invoking the real time execution process 316 and/or batch execution process 318 with respect to the trained machine learning model, retrieving relevant input data (e.g., updated input data), and/or performing the real time execution and/or batch execution of the trained machine learning model, for example. Additionally or alternatively, operation 904 may comprise the functionality attributed to any of the prediction processes 406 as defined and described with respect to FIG. 4.

At operation 906 of the process 900, an apparatus (such as, but not limited to, the apparatus 200 or circuitry thereof described above in connection with FIG. 2) generates a set of output data resulting from execution of the trained machine learning model (at operation 904). In various embodiments, the output data may comprise one or more predictions, recommendations, and/or insights concerning the one or more operational systems 110 and/or, more particularly, a particular object with which the trained machine learning model is associated (e.g., via the model association metadata). Operation 906 may comprise the functionality attributed to the orchestration process 314, real time execution process 316, and/or batch execution process 318, as described with respect to FIG. 3, including invoking the real time execution process 316 and/or batch execution process 318 with respect to the trained machine learning model and/or performing the real time execution and/or batch execution of the trained machine learning model, for example. Additionally or alternatively, the output data generated at operation 906 may comprise and/or correspond to output data as defined and described with respect to FIG. 3. Additionally or alternatively, the output data generated at operation 906 may comprise and/or correspond to any of the predictions 460 as defined and described with respect to FIG. 4.

At operation 908 of the process 900, an apparatus (such as, but not limited to, the apparatus 200 or circuitry thereof described above in connection with FIG. 2) adds the output data (generated at operation 906) to a prediction store. In various embodiments, adding the output data to the prediction store at operation 908 may comprise storing the output data to a data repository (e.g., of the one or more data repositories 150) associated with the prediction store. The prediction store referred to with respect to operation 908 may correspond to the prediction store 320 as defined and described with respect to FIGS. 3 and 4, in one example. Additionally or alternatively, operation 908 may comprise the functionality attributed to the orchestration process 314, real time execution process 316, and/or batch execution process 318 as described with respect to FIG. 3, and/or any of the prediction processes 406 as described with respect to FIG. 4, including storing output data and/or predictions 460 to a data repository associated with the prediction store 320.

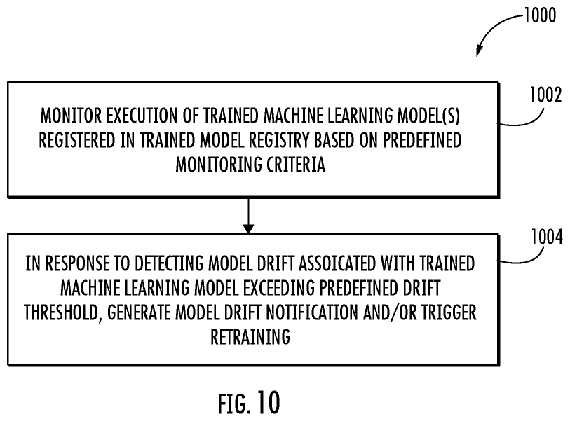

FIG. 10 illustrates a flowchart including operational blocks of an example process 1000 for monitoring execution of one or more machine learning models, in accordance with at least some example embodiments of the present disclosure.

The process 1000 begins at operation 1002, at which an apparatus (such as, but not limited to, the apparatus 200 or circuitry thereof as described above in connection with FIG. 2) monitors execution of one or more trained machine learning models registered in a trained model registry based at least in part on predefined monitoring criteria. Monitoring the execution of the trained machine learning model at operation 1002 may comprise and/or correspond to some or all of the functionality attributed to the monitoring process 322 as defined and described with respect to FIG. 3, for example, including determining a level of model drift for a trained machine learning model based at least in part on attributes and/or characteristics associated with the trained machine learning model(s) and/or execution thereof and/or determining whether the execution of the trained machine learning model(s) indicates a decrease in accuracy and/or precision of the trained machine learning model(s). The predefined monitoring criteria may correspond to and/or comprise the predefined monitoring criteria as defined and described with respect to FIG. 3, including a predefined drift threshold. The trained model registry referred to with respect to operation 1002 may correspond to the trained model registry 312 defined and described with respect to FIGS. 3 and 4, the global trained model registry 510, and/or any of the local trained model registries 512 defined and described with respect to FIGS. 5 and 6, for example. Additionally or alternatively, the trained machine learning model(s) referred to with respect to operation 1002 may correspond to machine learning model(s) that have been configured, trained, and/or registered according to some or all of the functionality defined and described with respect to the process 700 of FIG. 7 and/or the process 800 of FIG. 8. Additionally or alternatively, the execution of the trained machine learning model(s) monitored at operation 1002 may correspond to some or all of the model execution functionality defined and described with respect to the process 900 of FIG. 9.

At operation 1004 of the process 1000, an apparatus (such as, but not limited to, the apparatus 200 or circuitry thereof described above in connection with FIG. 2) performs one or more actions with respect to the trained machine learning model(s) monitored at operation 1002 based at least in part on the results of the monitoring. In various embodiments, the one or more actions performed at operation 1004 may comprise triggering retraining of the monitored machine learning model and/or generating notifications or alerts, to name a few examples. The one or more actions performed at operation 1004 may be performed based at least in part on and/or in response to a level of model drift determined for the trained machine learning model(s) via the monitoring and/or a decrease in accuracy and/or precision of the trained machine learning model(s) detected via the monitoring. Operation 1004 may comprise some or all of the functionality attributed to the monitoring process 322 as defined and described with respect to FIG. 3. Accordingly, in one example, at operation 1004, in response to determining that a level of model drift determined for a trained machine learning model (e.g., at operation 1002) exceeds a predefined drift threshold (e.g., as indicated in the predefined monitoring criteria), the apparatus generates a model drift notification and/or triggers retraining of the trained machine learning model.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communications network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communications network. Examples of communications networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communications network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. An apparatus comprising at least one processor and at least one non-transitory memory comprising program code stored thereon, wherein the at least one non-transitory memory and the program code are configured to, with the at least one processor, cause the apparatus to at least:
receive model configuration data and operational system context data, wherein the model configuration data identifies one or more machine learning models and a model training pipeline associated with each of the one or more machine learning models, and the operational system context data identifies one or more objects associated with one or more operational systems;
generate model association metadata based at least in part on the model configuration data and the operational system context data, wherein the model association metadata defines associations between the one or more machine learning models and the one or more objects;
for each association between a particular machine learning model and a particular object of the associations defined by the model association metadata, train the particular machine learning model according to the model training pipeline associated with the particular machine learning model in the model configuration data based at least in part on operational data associated with the particular object;
for each trained machine learning model, generate trained model metadata associated with the trained machine learning model based at least in part on the model association metadata; and
for each trained machine learning model, register the trained machine learning model in a trained model registry, including storing a trained model artifact representing the trained machine learning model and the trained model metadata associated with the trained machine learning model in a data repository associated with the trained model registry.

2. The apparatus of claim 1, wherein the model association metadata comprises model training parameters and model deployment parameters corresponding to each association between a particular machine learning model and a particular object of the associations defined by the model association metadata.

3. The apparatus of claim 1, wherein each trained machine learning model registered in the trained model registry is executed based at least in part on the stored trained model artifact and trained model metadata corresponding to the trained machine learning model.

4. The apparatus of claim 1, wherein the trained model metadata for each trained machine learning model comprises at least one of: an indication of whether the trained machine learning model is to be deployed, an execution schedule for the trained machine learning model, one or more execution types for the trained machine learning model, and one or more deployment endpoints for the trained machine learning model.

5. The apparatus of claim 1, wherein the trained model metadata for each trained machine learning model comprises one or more execution types for the trained machine learning model, the one or more execution types including at least one of: real time execution and batch execution.

6. The apparatus of claim 1, wherein the model association metadata is generated based at least in part on model association input received via a model association interface.

7. The apparatus of claim 1, wherein the one or more objects associated with the one or more operational systems include at least one of: one or more assets of the one or more operational systems, one or more sites containing the one or more operational systems, and one or more alarms defined for the one or more operational systems.

8. The apparatus of claim 1, wherein the operational system context data comprises at least one of: metadata associated with various components of the one or more operational systems and an ontology model describing one or more associations between various components of the one or more operational systems.

9. The apparatus of claim 1, wherein the at least one non-transitory memory and the program code are configured to, with the at least one processor, further cause the apparatus to at least:
monitor execution of each trained machine learning model registered in the trained model registry based at least in part on predefined monitoring criteria.

10. The apparatus of claim 9, wherein the monitoring of the execution of each trained machine learning model registered in the trained model registry comprises, in response to detecting model drift associated with a trained machine learning model exceeding a predefined drift threshold of the predefined monitoring criteria based at least in part on the execution of the trained machine learning model, at least one of: generating a model drift notification associated with the trained machine learning model and triggering retraining of the trained machine learning model.

11. A computer-implemented method comprising:
receiving model configuration data and operational system context data, wherein the model configuration data identifies one or more machine learning models and a model training pipeline associated with each of the one or more machine learning models, and the operational system context data identifies one or more objects associated with one or more operational systems;
generating model association metadata based at least in part on the model configuration data and the operational system context data, wherein the model association metadata defines associations between the one or more machine learning models and the one or more objects;
for each association between a particular machine learning model and a particular object of the associations defined by the model association metadata, training the particular machine learning model according to the model training pipeline associated with the particular machine learning model in the model configuration data based at least in part on operational data associated with the particular object;
for each trained machine learning model, generating trained model metadata associated with the trained machine learning model based at least in part on the model association metadata; and
for each trained machine learning model, registering the trained machine learning model in a trained model registry, including storing a trained model artifact representing the trained machine learning model and the trained model metadata associated with the trained machine learning model in a data repository associated with the trained model registry.

12. The method of claim 11, wherein the model association metadata comprises model training parameters and model deployment parameters corresponding to each association between a particular machine learning model and a particular object of the associations defined by the model association metadata.

13. The method of claim 11, wherein each trained machine learning model registered in the trained model registry is executed based at least in part on the stored trained model artifact and trained model metadata corresponding to the trained machine learning model.

14. The method of claim 11, wherein the trained model metadata for each trained machine learning model comprises at least one of: an indication of whether the trained machine learning model is to be deployed, an execution schedule for the trained machine learning model, one or more execution types for the trained machine learning model, and one or more deployment endpoints for the trained machine learning model.

15. The method of claim 11, wherein the trained model metadata for each trained machine learning model comprises one or more execution types for the trained machine learning model, the one or more execution types including at least one of real time execution and batch execution.

16. The method of claim 11, wherein the model association metadata is generated based at least in part on model association input received via a model association interface.

17. The method of claim 11, wherein the one or more objects associated with the one or more operational systems include at least one of: one or more assets of the one or more operational systems, one or more sites containing the one or more operational systems, and one or more alarms defined for the one or more operational systems.

18. The method of claim 11, wherein the operational system context data comprises at least one of: metadata associated with various components of the one or more operational systems and an ontology model describing one or more associations between various components of the one or more operational systems.

19. The method of claim 11, further comprising monitoring execution of each trained machine learning model registered in the trained model registry based at least in part on predefined monitoring criteria.

20. A computer program product comprising at least one non-transitory computer-readable storage medium having computer-readable program code portions stored therein, the computer-readable program code portions comprising an executable portion configured to:
receive model configuration data and operational system context data, wherein the model configuration data identifies one or more machine learning models and a model training pipeline associated with each of the one or more machine learning models, and the operational system context data identifies one or more objects associated with one or more operational systems;
generate model association metadata based at least in part on the model configuration data and the operational system context data, wherein the model association metadata defines associations between the one or more machine learning models and the one or more objects;
for each association between a particular machine learning model and a particular object of the associations defined by the model association metadata, train the particular machine learning model according to the model training pipeline associated with the particular machine learning model in the model configuration data based at least in part on operational data associated with the particular object;
for each trained machine learning model, generate trained model metadata associated with the trained machine learning model based at least in part on the model association metadata; and
for each trained machine learning model, register the trained machine learning model in a trained model registry, including storing a trained model artifact representing the trained machine learning model and the trained model metadata associated with the trained machine learning model in a data repository associated with the trained model registry.
